(19) United States
(12) Patent Application Publication
(10) Pub. No.: US 2018/0236539 A1
(43) Pub. Date: Aug. 23, 2018

(54) JETTING CERAMIC NANOPARTICLES FOR FABRICATION OF METAL PARTS

(71) Applicant: Desktop Metal, Inc., Burlington, MA (US)

(72) Inventors: Brian Daniel Kernan, Andover, MA (US); Michael Andrew Gibson, Boston, MA (US); Emanuel Michael Sachs, Newton, MA (US)

(21) Appl. No.: 15/901,826

(22) Filed: Feb. 21, 2018

Related U.S. Application Data
(60) Provisional application No. 62/461,726, filed on Feb. 21, 2017.

(51) Int. Cl. B22F 3/00; B33Y 10/00; B33Y 70/00

(52) U.S. Cl. CPC B22F 3/008; B33Y 10/00; B33Y 70/00; B22F 2302/25; B22F 2302/45; B22F 2302/20; B22F 2302/10

(57) ABSTRACT

Devices, systems, and methods are directed to the use of nanoparticles for improving fabrication of three-dimensional objects formed through layer-by-layer delivery of an ink onto a powder of metal particles in a powder bed. More specifically, the ink may include ceramic nanoparticles that may be maintained in a stable form, providing a shelf-life suitable for transportation and storage of the ink in large-scale commercial operations. The ink may be delivered onto the powder of the metal particles in the powder bed, where the ceramic nanoparticles may interact with the metal particles to improve strength of the three-dimensional objects being fabricated. Also, or instead, the nanoparticles may reduce the likelihood of defects associated with subsequent processing of the three-dimensional objects (e.g., slumping and shrinking and/or inadequate densification of the final part).

### CROSS-REFERENCE TO RELATED APPLICATION

This application claims the benefit of U.S. Provisional Patent Application No. 62/461,726, filed Feb. 21, 2017, the entire contents of which are incorporated herein by reference.

### BACKGROUND

Binder jetting is an additive manufacturing technique based on the use of an ink to join particles of a powder to form a three-dimensional object. In particular, the ink is jetted onto successive layers of the powder in a powder bed such that the layers of the material adhere to one another form a three-dimensional green part. Through subsequent processing, the three-dimensional green part can be formed into a finished three-dimensional metal part. However, the subsequent processing can create structural or aesthetic artifacts. Thus, there remains a need for binder jetting techniques that mitigate defects or otherwise modify or improve material properties as the three-dimensional green parts are processed into finished parts.

### SUMMARY

Devices, systems, and methods are directed to the use of nanoparticles for improving fabrication of three-dimensional objects formed through layer-by-layer delivery of an ink onto a powder of metal particles in a powder bed. More specifically, the ink may include ceramic nanoparticles that may be maintained in a stable form, providing a shelf-life suitable for transportation and storage of the ink in large-scale commercial operations. The ink may be delivered onto the powder of the metal particles in the powder bed, where the ceramic nanoparticles may interact with the metal particles to improve strength of the three-dimensional objects being fabricated. Also, or instead, the nanoparticles may reduce the likelihood of defects associated with subsequent processing of the three-dimensional objects (e.g., slumping and shrinking and/or inadequate densification of the final part).

According to yet another aspect, an additive manufacturing method may include spreading a plurality of layers of a powder across a powder bed, the powder including particles of a first metal, delivering an ink to each layer of the plurality of layers of the powder in a respective controlled two-dimensional pattern associated with each layer, the ink including ceramic nanoparticles, and the controlled two-dimensional patterns of the plurality of layers collectively defining a three-dimensional object, and modifying the ceramic nanoparticles in the three-dimensional object, the modification of the ceramic nanoparticles combining at least one material component of the ceramic nanoparticles with the first metal in the three-dimensional object.

In certain implementations, the particles of the first metal may have a first average particle size and the ceramic nanoparticles have a second average particle size less than the first average particle size. Further or instead, at least one material component of the ceramic nanoparticles may be an element decomposable into a second metal (e.g., a metal alloyable with the first metal).

In some implementations, combining the at least one material component of the ceramic nanoparticles with the first metal includes sintering the three-dimensional object. Sintering the three-dimensional object may include, for example, heating the three-dimensional object in the powder bed. In some instances, the powder bed may be heated to a temperature greater than a sinter temperature of the ceramic nanoparticles and less than a sinter temperature of the particles of the first metal.

In certain implementations, modifying the ceramic nanoparticles in the three-dimensional object may include decomposing the ceramic nanoparticles to the at least one material component. For example, decomposing the ceramic nanoparticles may include exposing the three-dimensional object to a reducing environment for the ceramic nanoparticles. Further or instead, modifying the ceramic nanoparticles in the three-dimensional object may include dissolving the ceramic nanoparticles into the first metal.

In some implementations, the ceramic nanoparticles include at least one metal oxide. Examples of the at least one metal oxide include one or more of copper oxide, iron oxide, nickel oxide, or chromium oxide. Further or instead, the ceramic nanoparticles may include at least one metal nitride (e.g., one or more of chromium nitride or boron nitride). Still further or instead, the ceramic nanoparticles may include at least one metal hydride (e.g., titanium hydride). In some instances, the ceramic nanoparticles may be formed of at least one carbide. The at least one carbide may be, for example, one or more of silicon carbide, vanadium carbide, tungsten carbide, or chromium carbide.

In certain implementations, the ink may further include a polymer in which the ceramic nanoparticles are suspended as the ink is delivered to each layer of the powder. The polymer may, for example, a decomposition temperature of greater than about 300° C.

In some implementations, the ink may further include an aqueous carrier in which the ceramic nanoparticles are suspended as the ink is delivered to each layer of the powder.

### BRIEF DESCRIPTION OF THE DRAWINGS

The systems and methods described herein are set forth in the appended claims. However, for the purpose of explanation, several implementations are set forth in the following drawings:

FIG. 1 is a schematic representation of an additive manufacturing system for forming a three-dimensional object from a powder in a powder bed.

FIG. 2 is a schematic representation of an additive manufacturing plant including the additive manufacturing system of FIG. 1.

FIG. 3 is a flowchart of an exemplary method of forming and processing the three-dimensional object of FIG. 1.

FIG. 4 is a schematic representation of nanoparticles that have been modified through sintering to form a sinter neck between particles of the powder of FIG. 1.

FIG. 5 is a schematic representation of an ink including filaments suspended in a carrier.

FIG. 6 is flowchart of an exemplary method of additive manufacturing of a three-dimensional object with an ink including filaments suspended in a carrier.

FIG. 7 is a schematic representation of an ink including nanoparticles of a metal suspended in a saturated solution of ions of the metal.

FIG. 8 is a flowchart of an exemplary method of forming a non-oxidizing aqueous solution of metallic nanoparticles.

FIG. 9 is a schematic representation of an ink including ceramic nanoparticles.

FIG. 10 is a schematic representation of an ink including first nanoparticles including a metal oxide and second nanoparticles including a reducing agent of the metal oxide.

FIG. 11 is a flowchart of an exemplary method of additive manufacturing method including multi-phase sintering.

FIG. 12 is a flowchart of an exemplary method of additive manufacturing including controlled aggregation of nanoparticles.

FIG. 13 is a flowchart of an exemplary method of additive manufacturing including layer-by-layer hardening of an ink forming a three-dimensional object.

FIG. 14 is a flowchart of an exemplary method of an additive manufacturing method including distributing nanoparticles based on powder density.

FIG. 15 is a flowchart of an exemplary method of controlling an additive manufacturing system to distribute nanoparticles based on powder density.

FIG. 16 is a cross-section of a particle coated with nanoparticles.

FIG. 17 is a flowchart of an exemplary method 1700 of additive manufacturing a three-dimensional object from a powder including particles coated with nanoparticles.

FIG. 18 is a schematic representation of an ink including micelles suspended in a carrier.

FIG. 19 is a schematic representation of an ink including bilayers suspended in a carrier.

FIG. 20 is a flowchart of an exemplary method of additive manufacturing a three-dimensional object using an ink including supramolecular assemblies.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and, similarly, the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

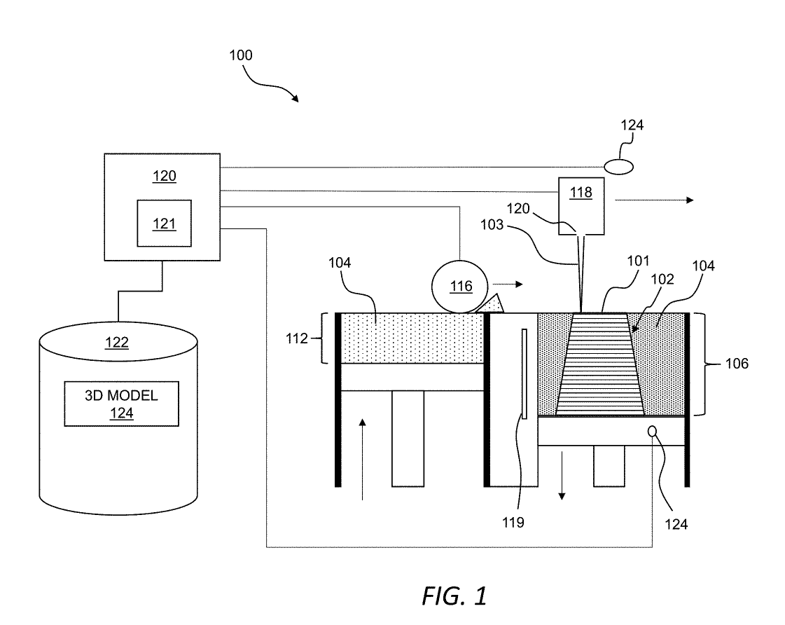

Referring now to FIG. 1, an additive manufacturing system 100 may be used to form a three-dimensional object 102 through any one or more of the various different binder jetting techniques described herein. For example, the additive manufacturing system 100 may deliver an ink 103 onto successive layers 101 of a powder 104 of inorganic particles (e.g., metal particles, ceramic particles, or a combination thereof) in a powder bed 106 such that, along respective two-dimensional patterns of the ink 103 in the layers 101 of the powder 104, the layers 101 of the powder 104 may adhere to one another to form cross-sections of the three-dimensional object 102. The three-dimensional object 102, when coupled by the ink 103 within the powder bed 106 in this manner, forms a green part that, as described in greater detail below, may be subsequently processed, such as through sintering or other thermal processing, to form a finished metal or ceramic part. As described in greater detail below, nanoparticles may be introduced into the three-dimensional object 102 to fill a substantial portion of void space of the powder 104 such that the nanoparticles are dispersed among particles of the powder to improve strength of the three-dimensional object 102, making the three-dimensional object 102 less prone to defects associated with subsequent processing used to form the three-dimensional object 102 into the final metal or ceramic part. As also described in greater detail below, certain techniques described herein for the introduction of nanoparticles into the three-dimensional object 102 address practical constraints associated with the commercial viability of nanoparticle additives such as shelf-life of the ink 103, uniform distribution of ink 103 (and components thereof) within the three-dimensional object 102 in the powder bed 106, and/or adequate densification of the three-dimensional object 102 after thermal processing.

In the disclosure that follows, an overview of devices, systems, and methods for the use nanoparticles in binder jetting fabrication of dense parts (e.g., metal or ceramic) is followed by descriptions of specific implementations useful for addressing technical challenges associated with the introduction and modification of nanoparticles in binder jetting fabrication of high-quality, dense parts in large-scale commercial operations.

Overview of Nanoparticles in Binder Jetting Fabrication of Dense Parts

The additive manufacturing system 100 may include the powder bed 106, a powder supply 112, a spreader 116, and a printhead 118. The spreader 116 may be movable from the powder supply 112 to the powder bed 106 and along the powder bed 106 to spread each layer of a plurality of layers 101 of the powder 104 across the powder bed 106. In certain instances, the printhead 118 is movable across the powder bed 106 in coordination with movement of the spreader 116. Thus, for example, the spreader 106 may precede the printhead 118 across the powder bed 106 to form a layer of the powder 104 on top of the powder bed 106 and, as the printhead 118 moves over the powder bed 106, the printhead 118 may deliver the ink 103 to the layer of the powder 104 on top of the powder bed 106 in a controlled two-dimensional pattern associated with the given layer. As should be readily appreciated, the three-dimensional object 102 is formed as the ink 103 is delivered in respective controlled two-dimensional patterns along successive layers. For the sake of clarity and economy of explanation, the spreader 116 and the printhead 118 shall be described as being movable over the powder bed 106. However, any manner and form of relative movement of components of the additive manufacturing system 100 may be used to carry out any one or more of the binder jetting processes described herein. Thus, for example, the powder bed 106 may be, further or instead, movable with respect to one or more of the spreader 116 and the printhead 118 to achieve relative movement of components, as necessary to carry out any one or more of the binder jetting processes described herein.

The spreader 116 may generally span the powder bed 106 in at least one linear dimension such that the spreader 116 may distribute a layer of the powder 104 on top of the build volume 115 in a single pass. As an example, the spreader 116 may include a roller rotatable about an axis perpendicular to an axis of movement of the spreader 116 across the powder bed 106. In use, rotation of the roller about the axis perpendicular to the axis of movement of the spreader 116 may spread the powder 104 from the powder supply 112 to the powder bed 106 and form a layer of the powder 104 along the powder bed 106. Accordingly, the plurality of layers 101 of the powder 104 may be formed in powder bed 106 through repeated movement of the spreader 116 across the powder bed 106. The thickness of each layer of the powder 104 may be substantially uniform from layer to layer, allowing for variations associated with spreading the powder 104. As an example, the thickness of each layer may be greater than about 25 microns and less than about 100 microns (e.g., about 50 microns). Other dimensions are additionally or alternatively possible and may be a function of a variety of factors, including dimensional control of the three-dimensional object 102, composition of the powder 104, penetration depth of the ink 103, and the like.

The powder 104 spread along the powder bed 106 by the spreader 116 may be a collection of particles flowable relative to one another in response to force applied to the powder 104 by the spreader 116. The powder 104 may include any manner and form of particles suitable for being formed into a metal or ceramic final part and, thus, may include inorganic particles (e.g., metal particles and/or ceramic particles), polymeric particles, and combinations thereof, all of which may be coated or uncoated as required or as may be beneficial for a given fabrication technique. The powder 104 may be substantially homogenous, allowing for degrees of impurity and/or inhomogeneity having an insignificant impact on dimensions and quality of a final part formed from the three-dimensional object 102. The composition of the particles of the powder 104 may vary according to a variety of factors including, by way of example and not limitation, the composition of the final part to be formed from the three-dimensional object 102, the composition of the ink 103 delivered to the powder 104, the type or types of post-processing to be used to form the three-dimensional object 102 into a final part, and combinations thereof. In general, however, the powder 104 may include a single material or a combination of materials. Further, as described in greater detail below, the powder 104 may include microscale particles, and nanoparticles may be delivered to the powder bed 106 via the ink 103. Additionally, or alternatively, as described in greater detail below, the powder 104 may include nanoscale particles interspersed with the microparticles. Still further, or instead, the powder 104 may have a predetermined size distribution of particles to facilitate achieving one or more target parameters in a final part formed from the three-dimensional object 102. As used herein, microscale particles shall be understood to be particles having an average particle size greater than about 0.1 microns and less than about 100 microns. Similarly, nanoscale particles shall be understood to be particles having a particle size distribution with an average particle size of greater than about 1 nanometer and less than about 100 nanometers. More generally, any particles having particle size distribution with a mean, median or mode of between about one nanometer and about one hundred nanometers may be considered nanoparticles as that term is used herein. To account for the particles having irregular shape, it should be understood that the term “particle size,” as used herein, correspond to the diameter of a sphere that has the same volume as a given particle, as is commonly used in sieve analysis. It should also be appreciated that a measured particle size or particle size distribution may depend on the measurement technique used as well as other factors such as irregularities or high aspect ratios in the shape of the particles being characterized. Thus, the numbers provided above should be understood to specify general ranges rather than specific, absolute limitations on the physical properties of individual particles or particle size distributions for microscale particles and nanoparticles as contemplated herein.

The printhead 118 may define an ejection orifice 120 directed toward the powder bed 106 as the printhead 118 moves across the powder bed 106. The printhead 118 may include, for example, one or more piezoelectric elements associated with the ejection orifice 120. Continuing with this example, in use, each piezoelectric element may be selectively actuated such that displacement of the piezoelectric element may expel the ink 103 from the ejection orifice 120. In certain implementations, additional printheads and/or additional ejection orifices may be used to deliver the ink 103 without departing from the scope of the present disclosure. For example, multiple printheads may be used to deliver a plurality of liquids for in situ formulation of the ink 103 in the powder bed 106, which may be useful in implementations in which it is desirable to vary concentration of one or more components of the ink 103 along a given layer of the powder 104 along the powder bed 106.

In general, the ink 103 delivered by the printhead 118 may include any liquid, suspension, colloid, solution, dispersion, or combination(s) thereof, delivered to the powder bed 106 to promote binding—with or without further processing—between particles of the powder 104 along the portions of the layers 101 collectively forming the three-dimensional object 102. Thus, as described in greater detail below, the ink 103 may include one or more polymers or similar material(s) useful for binding particles of the powder 104 upon introduction of the ink 103 to a layer of the powder 104 within the powder bed 106. Additionally, or alternatively, as also described in greater detail below, the ink 103 may include nanoparticles, e.g., to facilitate forming sinter necks between particles of the powder 104 in the powder bed 106. In such instances, the ink 103 may be an aqueous solution, free or substantially free of a polymer, which, as a significant advantage, may be useful for reducing carbon contamination that can occur during thermal processing of polymer-based inks. Further, or instead, the ink 103 may include any one or more of various additives useful for maintaining the ink 103 in a substantially stable form.

The additive manufacturing system 100 may include a heater 119 in thermal communication with the powder bed 106. The thermal communication between the heater 119 and the powder bed 106 may include any one or more of various different forms of thermal communication and, thus, may include conductive, convective, and/or radiative thermal communication. As an example, the heater 119 may include a resistance heater embedded in one or more walls of the powder bed 106. Additionally, or alternatively, the heater 119 may include an induction heater.

The additive manufacturing system 100 may further include a controller 120 in electrical communication with the powder bed 106, the powder supply 112, the spreader 116, the printhead 118, and the heater 119. The controller 120 may include one or more processors 121 operable to control the powder bed 106, the powder supply 112, the spreader 116, the printhead 118, and the heater 119 relative to one another to form the three-dimensional object 102. In use, the one or more processors 121 of the controller 120 may execute instructions to control z-axis movement of one or more of the powder bed 106 and the powder supply 112 relative to one another as the three-dimensional object 102 is being formed. For example, the one or more processors 121 of the controller 120 may execute instructions to move the powder supply 112 in a z-axis direction toward the spreader 116 to direct a quantity of the powder 104 in the powder supply 112 toward the spreader 116 as each layer of the three-dimensional object 102 is formed and to move the powder bed 106 in a z-axis direction away from the spreader 116 to accept each new layer of the powder 104 along the top of the powder bed 106 as the spreader 116 moves across the powder bed 106. Additionally, or alternatively, the one or more processors 121 of the controller 120 may control movement of the spreader 116 from the powder supply 112 to the powder bed 106 to move successive layers 101 of the powder 104 across the powder bed 106. Further, or instead, the one or more processors 121 of the controller 120 may control movement and/or actuation of the printhead 118 to deliver the ink 103 according to a respective controlled two-dimensional pattern associated with a given layer of the powder 104.

In certain implementations, the controller 120 may control the heater 119 to heat the three-dimensional object 102 in the powder bed 106 to a target temperature (e.g., greater than about 100° C. and less than about 600° C.). For example, in instances in which the nanoparticles are delivered to the powder bed 106 via the ink 103 and, thus, distributed only along the three-dimensional object 102 defined by the ink 103 in the powder bed 106, the target temperature may be greater than a sintering temperature of the nanoparticles and less than a sintering temperature of the particles of the powder 104 forming the three-dimensional object 102. Continuing with this example, heating the three-dimensional object 102 to the target temperature in the powder bed 106 may form at least a portion of the nanoparticles into sinter necks joining the particles of the powder 104 to one another along the three-dimensional object 102 such that the three-dimensional object 102 may be removed from the powder bed 106 and subjected to one or more finishing processes with a reduced likelihood of deformation or other defects, as compared to a three-dimensional object without sinter necks.

The additive manufacturing system 100 may further include a non-transitory, computer readable storage medium 122 in communication with the controller 120 and having stored thereon a three-dimensional model 124 and instructions for causing the one or more processors 121 to carry out any one or more of the methods described herein. In general, as the plurality of layers 101 of the powder 104 are introduced to the powder bed 106 and the ink 103 is delivered from the printhead 118 to the powder 104 in the powder bed 106, the three-dimensional object 102 may be formed according to a three-dimensional model 124 stored in the non-transitory, computer readable storage medium 122. In certain implementations, the controller 120 may retrieve the three-dimensional model 124 in response to user input, and generate machine-ready instructions for execution by the additive manufacturing system 100 to fabricate the three-dimensional object 102.

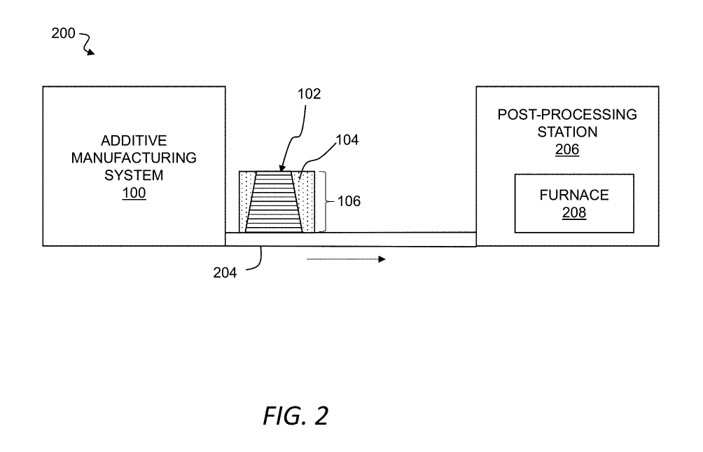

Referring now to FIGS. 1 and 2, an additive manufacturing plant 200 may include the additive manufacturing system 100, a conveyor 204, and a post-processing station 206. In certain instances, the three-dimensional object 102 may undergo some processing in situ in the powder bed 106, such as heating via the heater 119 to sinter the nanoparticles in the three-dimensional object 102 to form a stronger green part. Additionally, or alternatively, the powder bed 106 containing the three-dimensional object 102 may be moved along the conveyor 204 and into the post-processing station 206, where the three-dimensional object 102 may be formed into a dense part of metal and/or ceramic. The conveyor 204 may be, for example, a belt conveyor movable in a direction from the additive manufacturing system 100 toward the post-processing station 206. Additionally, or alternatively, the conveyor 204 may include a support on which the powder bed 106 is mounted and, in certain instances, the powder bed 106 may be moved from the additive manufacturing system 100 to the post-processing station 206 through movement of the support (e.g., through the use of actuators to move the support along rails or by an operator pushing the support).

In the post-processing station 206, the three-dimensional object 102 may be removed from the powder bed 106. The powder 104 remaining in the powder bed 106 upon removal of the three-dimensional object 102 may be, for example, recycled for use in subsequent fabrication of additional parts. Additionally, or alternatively, in the post-processing station 206, the three-dimensional object 102 may be cleaned (e.g., through the use of pressurized air) of excess amounts of the powder 104.

In the post-processing station 206, the three-dimensional object 102 may undergo any of various different densification processes related to the densification of the three-dimensional object 102 to form a final part. The densification process should be understood to include any process related to the removal of all or a portion of the ink 103 from the three-dimensional object 102. Further, or instead, densification processes may include reducing void space between particles in the three-dimensional object 102.

In certain instances, densification of the three-dimensional object 102 may include one or more debinding processes in the post-processing station 206 to remove all or a portion of the ink 103 from the three-dimensional object 102. In general, it shall be understood that the nature of the one or more debinding processes may include any one or more debinding processes known in the art and may be a function of the constituent components of the ink 103 and/or the powder 104. Thus, as appropriate for a given composition of the ink 103 and/or the powder 104, the one or more debinding processes may include, for example, a thermal debinding process, a supercritical fluid debinding process, a catalytic debinding process, and/or a solvent debinding process. For example, a plurality of debinding processes may be staged to remove components of the ink 103 in corresponding stages as the three-dimensional object 102 is formed into a finished part.

Additionally, or alternatively, densification of the three-dimensional object 102 may include one or more thermal processes in the post-processing station 206. The one or more thermal processes may be part of one or more debinding processes and, further or instead, may include a sintering process or other thermal process to reduce void space between particles in the three-dimensional object 102. The post-processing station 206 may include, for example, a furnace 208 that may be useful for thermally processing the three-dimensional object 102 to form a final part.

In certain implementations, thermally processing the three-dimensional object 102 may include any one or more sintering processes known in the art. That is, through the one or more sintering processes, the inorganic particles of the powder 104 may bond with one another and/or with other substances to form a finished part. Examples of such sintering processes include, but or not limited to, bulk sintering the inorganic particles in the solid state, liquid phase sintering, and transient liquid phase sintering.

In some implementations, thermally processing the three-dimensional object 102 may include infiltration of a liquid metal through the three-dimensional object 102. As a specific example, the inorganic particles of the powder 104 forming the three-dimensional object 102 may be presintered or otherwise bound to form a substantially solid powdered preform. A liquid metal may then be infiltrated into the substantially solid powdered preform as part of the thermal processing to form a final part from the three-dimensional object 102.

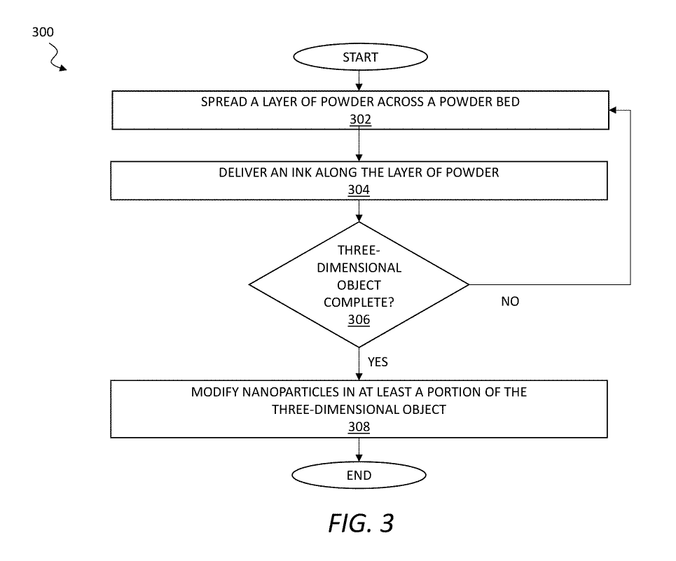

FIG. 3 is a flowchart of an exemplary method 300 of forming and processing a three-dimensional object into a dense part. Unless otherwise specified or made clear from the context, the exemplary method 300 may be implemented using any one or more of the various different additive manufacturing devices and systems described herein. Thus, for example, the exemplary method 300 may be implemented as computer-readable instructions stored on the computer readable storage medium 122 (FIG. 1) and executable by the controller 120 (FIG. 1) to operate the additive manufacturing plant 200 (FIG. 2) including the additive manufacturing system 100 (FIG. 1).

As shown in step 302, the exemplary method 300 may include spreading a layer of a powder across a powder bed. The powder may include any one or more of the powders described herein and may be spread according to a predetermined thickness associated with the layer being formed.

As shown in step 304, the exemplary method 300 may include delivering an ink (e.g., jetting the ink from a printhead moving over a powder bed) along the layer of the powder in a respective controlled two-dimensional pattern associated with the ink and the layer onto which the ink is delivered. The ink may be any one or more of the inks described herein. Thus, in certain instances described in greater detail below, the ink may include nanoparticles such that delivering the ink onto the layer introduces the nanoparticles along specific portions of the powder forming the layer. Additionally, or alternatively, nanoparticles may be substantially uniformly distributed in the powder prior to delivering the ink onto the layer. For certain formulations of the ink described herein, the ink may include one or more adhesive components (e.g., one or more polymers) that adhere particles of the powder to one another upon penetration of the ink into the given layer. Further, or instead, for some formulations of the ink described herein, the ink may adhere particles of the powder upon activation of the ink in the given layer. As described in greater detail below, activation of the ink may include thermally processing and/or chemically reacting nanoparticles associated with the ink and/or precipitating nanoparticles from a carrier associated with the ink.

As shown in step 306, the exemplary method 300 may include repeating one or more of the steps of spreading a layer of the powder across the powder bed and delivering the ink along a given layer of powder to form the three-dimensional object until a three-dimensional object is complete or some other suitable stopping condition is reached. In general, the three-dimensional object formed within the powder according to the exemplary method 300 may contain a distribution of the nanoparticles within particles of the powder throughout the volume of the three-dimensional object, with the nanoparticles filling a substantial portion of void space of the particles of the powder. The nanoparticles may be introduced into the three-dimensional object according to any one or more of the techniques described herein and, thus, more specifically, may be introduced into the three-dimensional object via the ink directed to the plurality of layers of the powder forming the three-dimensional object and/or by being premixed in the powder upon which the ink is directed to form the three-dimensional object. While a binder jetting ink may generally contain any of the nanoparticles or nanoparticle compositions described herein, it will be understood that such nanoparticle materials may also or instead be delivered separately from a binder, and may be distributed in a manner volumetrically coextensive with the binder or spatially independent from the binder, e.g., in regions of interface, around exterior object surfaces, or otherwise according to the structure and intended function of the nanoparticle composition(s).

As shown in step 308, the exemplary method 308 may include modifying the nanoparticles forming at least a portion of the three-dimensional object. Modifications to the nanoparticles may include changes to one or more physicochemical properties of the nanoparticles in the three-dimensional object. Examples of such changes in one or more physicochemical properties of the nanoparticles are described in greater detail below. In general, however, the nanoparticles in the three-dimensional object may be modified with the three-dimensional object in situ in the powder bed (e.g., through heat applied to the three-dimensional object 102 in the powder bed 106 through the heater 119 in FIG. 1 and/or through the furnace 208 in the post-processing station 206 in FIG. 2). Additionally, or alternatively, the nanoparticles in the three-dimensional object may be modified with the three-dimensional object outside of the powder bed (e.g., with the three-dimensional object 102 removed from the powder bed 106 in the post-processing station 206 in FIG. 2).

In certain implementations, the modifications to the nanoparticles in the three-dimensional object may include sintering the nanoparticles (e.g., in the powder bed 106 in FIG. 1 and/or in the post-processing station 206 in FIG. 2) to form necks between particles of the powder. The necks formed by the sintered nanoparticles may facilitate holding the particles of the powder in a substantially fixed orientation relative to one another, thus increasing green strength of the three-dimensional object. With the particles of the powder held together in this way, the three-dimensional object should be understood to be porous, which may be useful for any one or more of a variety of densification processes (e.g., sintering or infiltration) suitable for densifying the three-dimensional object to a final, fully-dense (or substantially fully-dense) part of metal and/or ceramic.

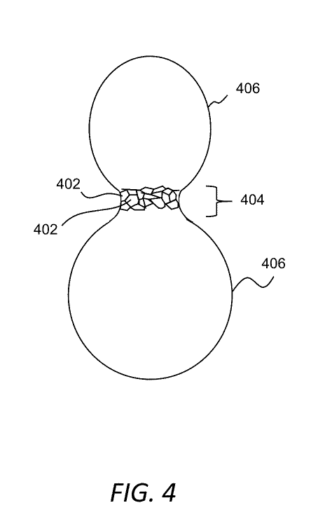

FIG. 4 is a schematic representation of nanoparticles 402 that have been modified through sintering to form a neck 404 between particles 406 of the powder 104 (FIG. 1). In general, the neck 404 may be formed through a process including evaporation of a least one fluid component carrying the nanoparticles 402 of the ink 103 (FIG. 1). More specifically, the last portion of the at least one fluid component of the ink 103 to evaporate is generally at regions formed by the shapes of curvature of contacting particles 406 and, therefore, the nanoparticles 402 may become concentrated in these regions of contact between the particles 406 as the at least one fluid component carrying the nanoparticles 402 evaporates. Because the nanoparticles 402 are concentrated at these regions of contact between the particles 406, and because the nanoparticles 402 have a lower sinter temperature than the adjacent particles 406, it should be appreciated that the application of heat to the three-dimensional object 102 (FIG. 1) may preferentially sinter the nanoparticles 402 at these regions of contact to form the neck 404 before other sintering occurs among the particles 406.

For the sake of clarity of representation, the neck 404 represents a coupling between two particles 406 of the powder 104 (FIG. 1) along the three-dimensional object 102. In an analogous manner, similar necks may be formed by other nanoparticles between other particles 406 within the three-dimensional object 102 (FIG. 1). Thus, in general, heating the three-dimensional object 102 may form a network of necks coupling particles 406 of the powder together throughout a volume of the three-dimensional object 102, imparting mechanical strength to the three-dimensional object 102 in the green state.

In general, the respective sinter temperatures of the nanoparticles 402 and the particles 406 may be a function of the size of the particles, as well as other parameters such as composition. Accordingly, for certain combinations of material of the nanoparticles 402 and the particles 406, achieving a suitable difference between a first sinter temperature associated with the particles 406 and the second sinter temperature associated with the nanoparticles 402 may be facilitated by controlling the respective size distributions of the particles 406 and the nanoparticles 402. For example, the particles 406 may have an average particle size greater than about 0.1 microns and less than about 100 microns and a size distribution of the particles may be cutoff at about 5 microns (or some higher threshold, which is bounded by a distribution with an average particle size greater than about 0.1 microns and less than about 100 microns) such that there few if any particles with a size less than about 5 microns (or the relevant threshold value). The cutoff in size distribution may remove fine particles from the distribution of the particles 406 to reduce the likelihood that a portion of the particles 406 will sinter at the second sinter temperature associated with the nanoparticles 402. Additionally, or alternatively, the nanoparticles 402 may have an average particle size of greater than about 1 nanometers and less than about 100 nanometers (e.g., greater than about 5 nanometers and less than about 50 nanometers). Unless otherwise specified or made clear from the context, these size distributions shall be understood to be generally applicable to any one or more of the combinations of particles and nanoparticles described herein.

In general, through further thermal processing, the material of the nanoparticles 402 and the particles 406 may combine to form an alloy or a metal matrix compound. The nanoparticles 402 and the particles 406 may be formed of a substantially purse material or from a combination of materials (e.g., an alloy, a metal enriched in an alloying element of another metal in the combination of materials, a metal with an oxide coating, etc.), with the composition of the nanoparticles 402 and the particles 406 based on any one or more of a variety of factors. In certain implementations, the nanoparticles 402 and the particles 406 may have the same composition. Additionally, or alternatively, the particles 406 may be an alloy of the nanoparticles 402. As an example, the particles 406 may be steel and the nanoparticles may be iron. Further, or instead, the nanoparticles 402 may be formed of one or more of the following materials: silver, gold, nickel, cobalt, molybdenum, vanadium, or chromium. In some implementations, the composition of the nanoparticles 402 and the particles 406 may be selected such that, after suitable homogenization heat treatment of the combination of a first metal associated with the particles 406 and a second metal associated with the nanoparticles 402, an average alloy composition of the first metal and the second metal may meet a predetermined material standard (e.g., a predetermined material standard set forth by the American Iron and Steel Institute, or another standard-setting organization). For example, the nanoparticles 402 and the particles 406 may be formed of one or more components of stainless steel and, post-processing, these components may be combined to form stainless steel in the finished part. Additional or alternative combinations of materials may be useful for more specific implementations described in greater detail below.

While sintering has been described as an example of a useful modification of the nanoparticles 402, other types of modifications may be additionally or alternatively useful. Examples of these other types of modifications are provided in the description that follows. More generally, in the description that follows, a variety of materials and methods for introducing and modifying nanoparticles in binder jetting fabrication of high-quality, dense parts are described. Unless otherwise specified or made clear from the context, the materials and methods described in the sections below should be understood to be implementable in a process using the additive manufacturing plant 200 (FIG. 2) including the additive manufacturing system 100 (FIG. 1) to form the three-dimensional object 102 according to any one or more of the methods described herein (e.g., according to the exemplary method 300 in FIG. 3). The sections below are provided for the sake of clarity of explanation and should generally not be understood to be limiting. Thus, for example, any one or more of the materials and methods described in greater detail below should be understood to be combinable with aspects of any one or more other materials and methods described in other sections, unless a contrary intent is specifically set forth or dictated by the context.

Inks Including High Aspect Ratio Nanoparticles

Referring now to FIGS. 1 and 4, in certain implementations, the area of contact between the nanoparticles 402 and the adjacent particles 406 may be a factor contributing to strength of the neck 404. That is, as compared to a smaller contact area, a larger contact area between the nanoparticles 402 and the adjacent particles 406 may improve local strength at the neck 404. With the formation of similar necks throughout the three-dimensional object 102, such an improvement of the local strength at the neck 404 may increase the overall green strength (e.g., mechanical strength of an object in the green state, prior to processing into a final part) of the three-dimensional object 102, making the three-dimensional object 102 more resistant to slumping or other defects associated with subsequent processing. Thus, in general, the nanoparticles 402 may be shaped to achieve a large bonded area with respect to the adjacent particles 406.

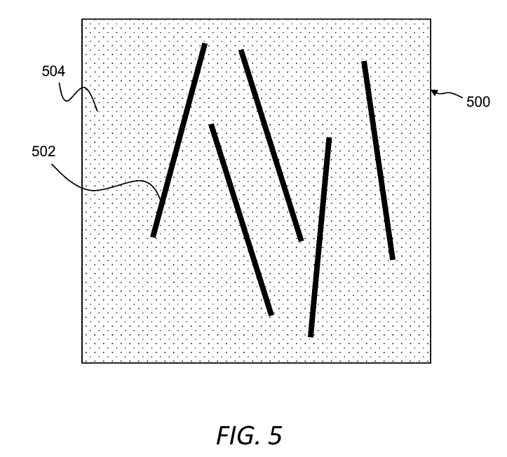

FIG. 5 is a schematic representation of an ink 500 including filaments 502 suspended in a carrier 504 (e.g., as a colloid). Unless otherwise specified or made clear from the context, it should be understood that the ink 500 may be used interchangeably with the ink 103 (FIG. 1). Thus, for example, the ink 500 may be used in combination with the additive manufacturing system 100 (FIG. 1) of the additive manufacturing plant 200 (FIG. 2) to carry out the exemplary method 300 (FIG. 3) to form the three-dimensional object 102.

Referring now to FIGS. 1 and 5, the filaments 502 may be sized according to competing considerations associated with achieving a large bonded area with particles of the inorganic material of the powder 104 in the powder bed 106 while being jettable in a controlled two-dimensional pattern by the printhead 118. Thus, for example, the filaments 502 may have a high length-to-width ratio (also known as a high aspect ratio) such that the filaments 502 are slender or threadlike. For example, the filaments 502 may have a length-to-width ratio of greater than about 10 to 1 and less than about 100 to 1. Further, or instead, the filaments 502 may have an average width of greater than about 1 nanometer and less than about 100 nanometers. In certain implementations, the filaments 502 may be substantially cylindrical or whisker shaped. For example, the filaments 502 may include crystalline whiskers. Additionally, or alternatively, the filaments 502 may be any one or more branched shapes with each section of the branched shape being slender or threadlike. While illustrated as straight segments, the filaments 502 may also or instead include curves, angles, branches or various segments of any of the foregoing.

The filaments 502 may include one or more inorganic materials, examples of which include, but are not limited at least one of iron, carbon, or silicon carbide. That is, the filaments 502 may be formed of one or more inorganic materials compatible with the inorganic material of the powder 104 in the powder bed 106. For example, the filaments 502 may be formed into sinter necks between particles of the powder 104 in the three-dimensional object 102 and, through subsequent processing, the one or more inorganic materials of the filaments 502 may combine with the inorganic material of the powder 104 in the powder bed 106 in the form of an alloy or a metal matrix composite. As a specific example, the inorganic material of the powder 104 may include a first metal, and the one or more inorganic materials of the filaments 502 may include a second metal. The first metal and the second metal may be alloyable with one another such that the first metal and the second metal form an alloy, e.g., during thermal processing of a finished part from the three-dimensional object 102.

The carrier 504 may be any one or more of various different media. As an example, the carrier 504 may include an aqueous medium and, further or instead, may include a polymer. In certain implementations, the carrier 504 may be advantageously compatible with maintaining the filaments 502 in a stable form over periods of time associated with transporting and storage of the ink 500 in large-scale commercial applications (e.g., several weeks or months). Thus, in instances in which the filaments 502 are formed of one or more metals, the carrier 504 may be a polymer to reduce or eliminate undesirable oxidation of the filaments 502 over long periods of time. Further or instead, in instances in which the filaments 502 are formed of one or more ceramics that are less likely to degrade than metals, the carrier 504 may be an aqueous medium. Because the aqueous medium does not include carbon, carbon contamination associated with removing the aqueous medium from the three-dimensional object 102 may advantageously be less than the carbon contamination associated with a polymer.

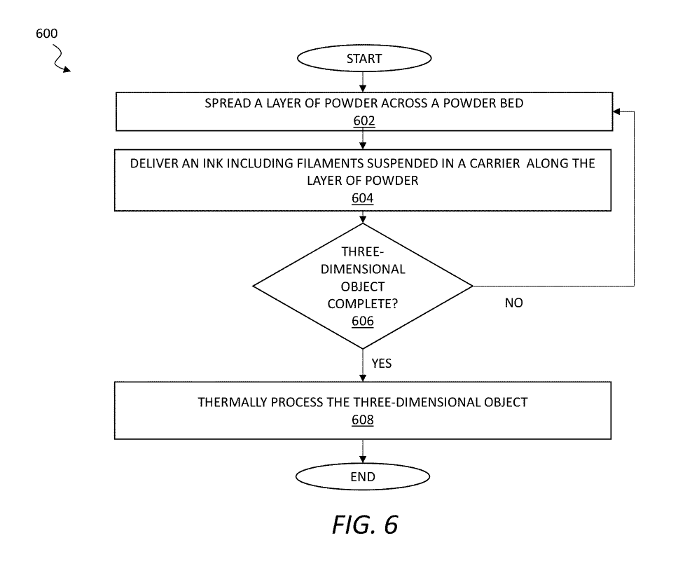

FIG. 6 is flowchart of an exemplary method 600 of additive manufacturing of a three-dimensional object with an ink including filaments suspended in a carrier. Unless otherwise specified or made clear from the context, the exemplary method 600 shall be understood to be carried out using the ink 500 (FIG. 5) in combination with the additive manufacturing plant 200 (FIG. 2) including the additive manufacturing system (FIG. 1).

As shown in step 602, exemplary method 600 may include spreading a layer of a powder across a powder bed. The powder may include particles of a first metal (e.g., one or more components of stainless steel) and, in general, the powder may be spread across the powder bed according to any one or more of the methods described herein. Thus, for example, the powder may be spread across the powder bed through movement of a roller moving across the powder bed.

As shown in step 604, the exemplary method 600 may include delivering the ink to the layer of the powder in a controlled two-dimensional pattern associated with the layer. Delivering the ink to the layer of the powder may include jetting the ink to the layer of the powder according to any one or more of the methods described herein, although other formed of depositing the ink on the layer of the powder are additionally or alternatively possible. In general, the carrier of the ink may penetrate the layer, and the filaments suspended in the carrier may also penetrate the layer.

As shown in step 606, the exemplary method 600 may include repeating the steps of spreading a layer and delivering the ink to the layer for a plurality of layers to form the three-dimensional object according to any one or more of the layer-by-layer fabrication processes described herein. The resulting three-dimensional object formed according to the exemplary method 600 may include a plurality of layers of a powder including particles of the first metal and the filaments distributed along the respective two-dimensional patterns in each layer of the plurality of layers of the powder, with the two-dimensional patterns of the filaments along the plurality of layers defining a perimeter of the three-dimensional object.

As shown in step 608, the exemplary method 600 may include thermally processing the three-dimensional object including the filaments and the particles of the first metal. Thermally processing the three-dimensional object may include any one or more of the various different thermal processes described herein. For example, the particles of the first metal may have a first sinter temperature and the filaments (e.g., formed of a second metal) may have a second sinter temperature less than the first sinter temperature, and the three-dimensional object may be heated to a temperature less than the first sinter temperature associated with the particles of the first metal and greater than the second sinter temperature associated with the filaments such that the filaments may form necks between the particles. Because of the shape of the filaments, the resulting necks formed from sintering the filaments may extend over a larger area than necks formed from sintering nanoparticles of other shapes (e.g., substantially spherical shapes). The larger area of these necks formed by the filaments may be useful for imparting improved green strength to the three-dimensional object.

In general, the respective sinter temperatures of the particles and the filaments may be a function of the size of the particles, as well as other parameters such as composition. Accordingly, for certain combinations of the first metal and the inorganic material of the filaments, achieving a suitable difference between the first sinter temperature associated with the particles of the first material and the second sinter temperature associated with the filaments may be facilitated by controlling the respective size distributions of the particles and the filaments according to any one or more of the size distributions described above.

Inks Including Non-Oxidizing Aqueous Solutions of Metal Nanoparticles

For the fabrication of dense parts having certain metal compositions, it may be desirable to deliver an ink including metallic nanoparticles to fill void space between particles of a metal in a layer on the powder bed. For example, the delivery of metallic nanoparticles directly to a layer of powder including metal particles may simplify the fabrication process. The use of metallic nanoparticles in an ink useful for large-scale commercial processes, however, may present certain constraints with respect to the type of carrier in which the metallic nanoparticles are suspended. That is, polymeric carriers in which the metallic nanoparticles may be stable for long periods of time may produce lower quality parts (e.g., through carbon contamination of the part as the polymer is removed through sintering). Conversely, metallic nanoparticles suspended in certain aqueous solutions may degrade through oxidation, transforming the metallic nanoparticles into material that is unsuitable for fabrication of metallic parts meeting a predetermined tolerance, such as a tolerance associated with mass production of parts. As described in greater detail below, such challenges associated with using metallic nanoparticles in binder jetting inks may be addressed through the use of engineered aqueous solutions.

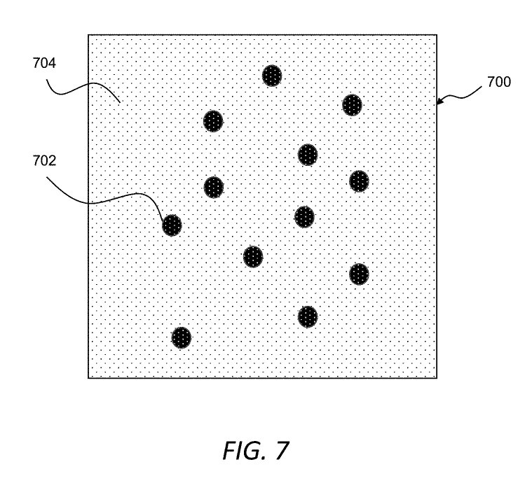

Referring now to FIG. 7, an ink 700 may include nanoparticles 702 of a metal suspended in a saturated solution 704 of ions of the metal (e.g., as a colloid). In general, the nanoparticles 702 in the saturated solution 704 do not oxidize because oxides are not thermodynamically favored under the conditions present in the saturated solution 704. More specifically, the saturated solution 704 may be a solution formed in an aqueous medium having a pH level in a range in which the favored result of the reaction between water of the aqueous medium and the metal is the formation of an ion of the metal in aqueous solution, rather than an oxidation reaction of the metal. An aqueous solution in which oxidation of a specific metal does not occur spontaneously may be considered a non-oxidizing solution with respect to the specific metal. Specific examples include copper in an acidic solution (pH less than about 7) and iron in a highly acidic solution (pH less than about 4). Under these conditions, as described in greater detail below, the saturated solution 704 may be formed by adding the metal to the aqueous medium until the aqueous medium is saturated with ions of the metal. Because the saturated solution 704 is saturated with ions of the metal, the metal of the nanoparticles 702 can remain in a stable form in the saturated solution 704, without significant degradation. It should be appreciated that the nanoparticles 702 in such a saturated solution 704 may be suspended in the ink 700 using only an aqueous medium and, notably, without the use of a polymer or other carbon-containing material that might otherwise introduce impurities into a finished part.

Referring now to FIGS. 1-4 and 7, the ink 700 may be used in addition to or instead of the ink 103 to form the three-dimensional object 102 using the additive manufacturing plant 200 including the additive manufacturing system 100. More specifically, the ink 700 may be used to introduce nanoparticles into a powder bed to carry out the exemplary method 300 to form a three-dimensional object. Accordingly, unless otherwise specified or made clear from the context, the nanoparticles 702 should be understood to be analogous to the nanoparticles 402. For example, the particles 406 in the powder bed 106 may include a first metal, and the nanoparticles 702 suspended in the ink 700 may include a second metal (e.g., copper or iron). As the ink 700 is delivered to the powder bed 106 on a layer-by-layer basis according to the exemplary method 300, the nanoparticles 702 in the ink 700 may combine with the particles 406 of the powder 104 in the powder bed 106 to form the three-dimensional object 102. The nanoparticles 702 forming at least a portion of the three-dimensional object 102 may be modified (e.g., sintered) to form necks 404 to impart improved green strength to the three-dimensional object 102.

The first metal and the second metal may be any of the various different combinations of metals described herein. Thus, for example, the second metal of the nanoparticles 702 may be different than the first metal of the particles 406 and, in certain instances, the first metal and the second metal may be alloyable with one another. Also, or instead, the sinter temperature associated with the nanoparticles 702 may be less than a sinter temperature associated with the particles 406. For example, on a Celsius temperature scale, the sinter temperature associated with the nanoparticles 702 of the second metal may be less than about 50 percent of the sinter temperature associated with the particles 406 of the first metal.

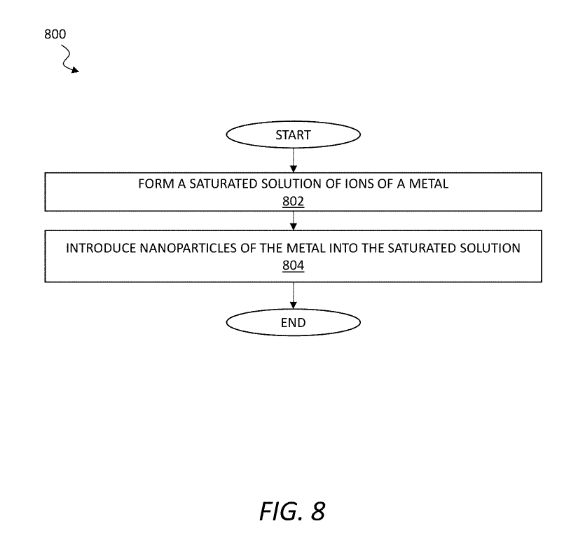

FIG. 8 is a flowchart of an exemplary method 800 of forming a non-oxidizing aqueous solution of metallic nanoparticles. In general, the exemplary method 800 may be used to form the ink 700 (FIG. 7). The exemplary method 800 may be carried out on-site, e.g., at a location where three-dimensional fabrication, or more specifically binder jetting, is being performed, to form the ink 700 (FIG. 7) shortly prior to or substantially contemporaneously with formation of the three-dimensional object 102 (FIG. 1). However, given the stability of the ink 700 (FIG. 7), the exemplary method 800 may also advantageously be carried out in an ink fabrication facility separate from a three-dimensional fabrication facility and the ink 700 (FIG. 7) may remain sufficiently stable for conventional commercial transport from the ink fabrication facility to the three-dimensional fabrication facility, as well for extended storage prior to use.

As shown in step 802, the exemplary method 800 may include forming a saturated solution of ions of a metal in an aqueous medium. In general, the aqueous medium may be formed to favor forming ions of the metal over oxidizing the metal. Thus, for example, the aqueous medium may have a target pH level—the target pH level being a function of the metal being used—prior to formation of the saturated solution.

With the aqueous medium at target conditions, the saturated solution may be formed, for example, by dissolving a metal-containing component in the aqueous medium. In certain implementations, the metal-containing component may be an elemental metal. For example, the elemental metal may be copper and, optionally, the aqueous medium may be nitric acid. In some implementations, the metal-containing component may be an iron-containing salt, such as one or more of iron chloride, iron hydroxide, iron sulfate, or iron nitrate.

As shown in step 804, the exemplary method 800 may include introducing nanoparticles of the metal into the saturated solution. The nanoparticles of the metal introduced into the saturated solution are in equilibrium with the ions of the metal in the saturated solution such that the nanoparticles remain stably suspended in the saturated solution. In certain implementations, agglomeration of the nanoparticles suspended in the saturated solution may be controlled by coupling a polymer to the nanoparticles of the metal. Such coupling may include adsorbing the polymer to the nanoparticles of the metal and/or sterically grafting the polymer of the nanoparticles of the metal. In general, the polymer may be any one or more of various different polymers couplable to the nanoparticles and useful for reducing or eliminating agglomeration of the nanoparticles, including sodium lauryl sulfate, and octylphenoxypolyethoxyethanol. More generally, an aqueous dispersion of particles may have any of the common anchoring polymers and stabilizing moieties known in the art to impart steric stabilization to a particulate or colloidal suspension, including but not limited to polystyrene, poly(vinyl acetate), and poly(methylmethacrylate) as anchor polymers, and poly(oxyethylene), poly(vinyl alcohol), and poly(acrylic acid) as stabilizing moeities. For non-aqueous dispersions, anchor polymers may include poly(acrylonitrile), poly(oxyethylene), and poly(ethylene), whereas stabilizing moieties may include polystyrene, poly(lauryl methacrylate), and poly(dimethylsiloxane). Additionally, or alternatively, agglomeration of the nanoparticles suspended in the saturated solution may be controlled by controlling ionic strength of the saturated solution to reduce electrostatic forces between the nanoparticles of the metal. For example, ionic strength may be controlled through controlled additions of a salt. The salt (e.g., ammonium nitrate) may be, for example, substantially non-reactive or miscible with respect to the metallic nanoparticles during a sintering process.

Inks Including Ceramic Nanoparticles

While inks including metal nanoparticles have been described, other types of nanoparticle materials may be used to form stable inks useful as part of large-scale binder jetting fabrication processes. As an example, inks may include ceramic nanoparticles. Because ceramic material does not undergo oxidation, it should be appreciated that ceramic nanoparticles may offer significant stability—particularly in aqueous media—as compared to other types of nanoparticles. Accordingly, ceramic nanoparticles may be useful for forming inks having a shelf-life suitable for periods associated with transportation and storage in large-scale manufacturing operations. In certain implementations, ceramic nanoparticles may be reduced to a metal that is combined with one or more metals in the powder bed to provide green strength to a three-dimensional object as described above. That is, ceramic nanoparticles may be stable in an ink and, through the fabrication process itself, may be formed into metal to offer advantages similar to those achievable with inks including metal nanoparticles.

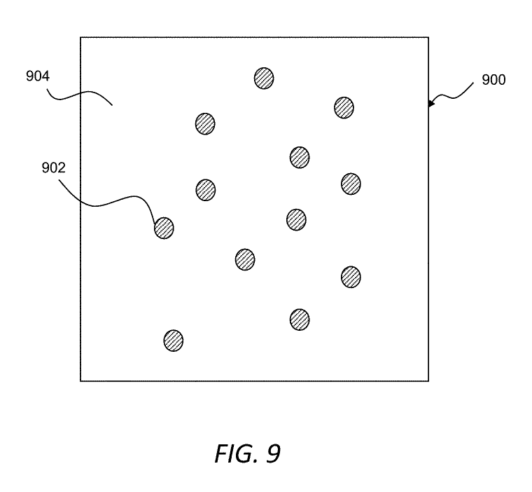

Referring now to FIG. 9, an ink 900 may include ceramic nanoparticles 902 suspended in a carrier 904. The carrier 904 and ceramic nanoparticles 902 may, for example, form a colloid or other suspension or the like retaining the ceramic nanoparticles 902 in a relatively homogenous, non-agglomerated distribution suitable for deposition in a binder jetting process or the like as contemplated herein. The carrier 904 may be any one or more of the various different carriers described herein and, thus, may include an aqueous medium and/or a polymer. As described above, an aqueous medium may advantageously reduce carbon contamination as compared to polymer-based carriers. Further or instead, as compared to an aqueous medium, a polymer-based carrier may have a higher decomposition temperature (e.g., greater than about 300° C.) useful for providing support to a three-dimensional object during thermal processing. Thus, more generally, the composition of the carrier 904 may be based on parameters of the overall process used to form the three-dimensional object. Similarly, the ceramic nanoparticles 902 may include any one or more of various different types of ceramics, with the type of ceramic suitable for a particular application based at least in part on the composition of the final part to be formed. As an example, a composition of the ceramic nanoparticles 902 may be based on a composition of a predetermined metal formed through reduction of the ceramic and intended for inclusion in the three-dimensional object. Thus, in certain implementations, the ceramic nanoparticles 902 may include at least one metal oxide, examples of which may include copper oxide, iron oxide, nickel oxide, or chromium oxide. In some implementations, the ceramic nanoparticles 902 may include at least one metal nitride, examples of which may include one or more of chromium nitride or boron nitride. Further or instead, the ceramic nanoparticles 902 may include at least one metal hydride, such as titanium hydride. Still further or instead, the ceramic nanoparticles 902 may include at least one carbide, such as silicon carbide, vanadium carbide, tungsten carbide, or chromium carbide.

In certain implementations, the ceramic nanoparticles 902 may be formed entirely of one or more ceramic materials. In some implementations, however, the ceramic nanoparticles 902 may include a ceramic coating over a base material (e.g., a base metal). Continuing with this example, the ceramic coating may protect the base material from premature reactions. Thus, stated differently, at least an outer surface of the ceramic nanoparticles 902 includes one or more ceramic materials and an inner portion of the ceramic nanoparticles 902 may include the same ceramic material or materials or another material component, such as a metal, useful for formation of a target composition of a final part.

Referring now to FIGS. 1-4 and 9, the ink 900 may be used in addition to or instead of the ink 103 to form the three-dimensional object 102 using the additive manufacturing plant 200 including the additive manufacturing system 100. More specifically, the ink 900 may be used to introduce nanoparticles into a powder bed to carry out the exemplary method 300 to form a three-dimensional object. Accordingly, unless otherwise specified or made clear from the context, the ceramic nanoparticles 902 should be understood to be analogous to the nanoparticles 402. Thus, as the ink 900 is delivered to the powder bed 106 on a layer-by-layer basis according to the exemplary method 300, the nanoparticles 902 in the ink 900 may combine with the particles 406 of the powder 104 in the powder bed 106 to form the three-dimensional object 102. The nanoparticles 902 forming at least a portion of the three-dimensional object 102 may be modified (e.g., sintered) to form necks 404 to impart improved green strength to the three-dimensional object 102.

In certain implementations, the particles 406 of the powder 104 and the ceramic nanoparticles 902 may have relative size distributions useful for processing the three-dimensional object 102 and, further or instead, ultimately useful for forming a finished part having a composition within a predetermined tolerance. Thus, for example, the particles 406 may have a first average particle size, and the ceramic nanoparticles 902 may have a second average particle size less than the first average particle size.

In some implementations, at least one material component of the ceramic nanoparticles 902 may be a second metal. The second metal forming at least one material component of the ceramic nanoparticles 902 and the first metal of the particles 406 may be any combination of metals described herein, unless otherwise specified or made clear from the context. Thus, for example, the first metal and the second metal may be the same metal. As another example, the second metal may be alloyable with the first metal (e.g., alloyable to form stainless steel).

As part of the exemplary method 300 of forming and processing the three-dimensional object 102, the ceramic nanoparticles 902 forming at least a portion of the three-dimensional object 102 may be modified according to any one or more of various different processes useful for combining at least one material component of the ceramic nanoparticles 902 with the first metal of the particles 406.

In certain implementations, combining the at least one material component of the ceramic nanoparticles 902 with the first metal of the particles 406 may include decomposing the ceramic nanoparticles 902 to the at least one material component such that the at least one material component may be combined with the first metal of the particles. Decomposing the ceramic nanoparticles 902 may include, for example, exposing the three-dimensional object to a reducing environment (e.g., a gas flowed into and over the three-dimensional object 102) for the ceramic nanoparticles 902, with the reduction reaction of the ceramic nanoparticles 902 producing the second metal, which may be combined with the first metal according to any one or more of the various different techniques described herein. As a specific example, the ceramic nanoparticles 902 may include iron oxide, which may undergo a reduction reaction to form iron combinable, in certain instances, with the first metal of the particles 406 to form steel.

In some implementations, the ceramic nanoparticles 902 in the three-dimensional object 102 may be sintered, such as by heating the three-dimensional object 102 in the powder bed 106 or outside of the powder bed 106. That is, the three-dimensional object 102 may be heated to a temperature greater than a sinter temperature of the ceramic nanoparticles and less than a sinter temperature of the particles of the first metal and, in certain instances, the at least one material component of the ceramic nanoparticles 902 may form sinter necks 404 between the particles 406 of the first metal to provide green strength to the three-dimensional object 102.

In certain implementations, the ceramic nanoparticles 902 in the three-dimensional object 102 may be dissolved into the first metal of the particles 406. That is, rather than undergoing decomposition as the three-dimensional object 102 undergoes processing, the modification of the ceramic nanoparticles 902 in the three-dimensional object may include dissolving the ceramic nanoparticles 902 without changing the composition of the ceramic nanoparticles 902. Dissolving the ceramic nanoparticles 902 into the first metal may be useful, for example, for forming a metal matrix composite or a hybrid composite.

Inks Including Oxides and Reducing Agents

While ceramic nanoparticles introduced into three-dimensional objects through inks may be decomposed by exposing the three-dimensional object to a reducing environment, other approaches to reducing ceramic nanoparticles in the three-dimensional objects are additionally or alternatively possible. For example, inks may include a metal oxide and a reducing agent of the metal oxide suspended in a carrier. The metal oxide may offer advantages with respect to stability, as described above with respect to the ceramic nanoparticles, while the presence of the reducing agent in the ink may facilitate reducing the metal oxide to a metal useful for forming a final part. That is, the three-dimensional object may be nanoporous, which presents challenges with respect to the introduction of a reducing gas into the three-dimensional object to reduce a metal oxide and removal of a byproduct of the reduction reaction from the three-dimensional object. Delivering the reducing agent along with the metal oxide in an ink may facilitate providing the reducing agent and the metal oxide together locally within the three-dimensional object and, therefore, may address the challenges associated with reducing a metal oxide in a nanoporous three-dimensional object by providing a pathway for reducing the metal oxide before one or more additional layers of material are added (or concurrently with the addition of these layers).

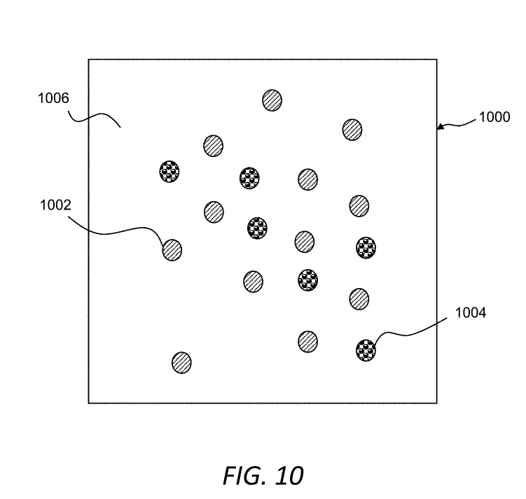

Referring now to FIG. 10, an ink 1000 may include first nanoparticles 1002, second nanoparticles 1004, and a carrier 1006 in which the first nanoparticles 1002 and the second nanoparticles 1004 are suspended (e.g., forming a colloid). The first nanoparticles 1002 may include a metal oxide and second nanoparticles 1004 including a reducing agent of the metal oxide. The carrier 1006 may include an aqueous medium and/or a polymer, with the composition of the carrier 1006 based at least in part on that composition of the first nanoparticles 1002 and the second nanoparticles 1004. In general, the first nanoparticles 1002 and the second nanoparticles 1004 may be physically separated by the carrier 1006 from one another, or otherwise substantially inert with respect to one another in the carrier 1006. Thus, the first nanoparticles 1002 and the second nanoparticles 1004 suspended in the carrier 1006 may have a shelf-life suitable for transportation and storage associated with large-scale fabrication processes.

In general, the metal oxide of the first nanoparticles 1002 may be at least one material component of the first nanoparticles 1002. Thus, for example, the metal oxide may be a coating on a base material (e.g., a metal) of the first nanoparticles. In such instances, the coating may protect the base material from premature reactions in the ink 1000 such that the base material may remain stable in the ink 1000. Further, or instead, the metal oxide may form substantially the entire volume of the first nanoparticles 1002.

The metal oxide associated with the first nanoparticles 1002 may be any one or more metal oxides having a reduction reaction with a solid reducing agent. For example, the metal oxide associated with the first nanoparticles 1002 may have a reducing reaction with elemental carbon as the reducing agent of the second nanoparticles 1004 according to the following chemical reaction:

MₓO_{y}+yC_{solid}→xM+yCO_{(g)}

As a specific example, the metal oxide associated with the first nanoparticles 1002 may include one or more of nickel oxide or copper oxide. Further, or instead, the second nanoparticles 1004 may include carbon black.

Referring now to FIGS. 1-4 and 10, the ink 1000 may be used in addition to or instead of the ink 103 to form the three-dimensional object 102 using the additive manufacturing plant 200 including the additive manufacturing system 100. More specifically, the ink 1000 may be used to introduce nanoparticles into a powder bed to carry out the exemplary method 300 to form a three-dimensional object. Accordingly, unless otherwise specified or made clear from the context, the first nanoparticles 1002 should be understood to be analogous to the nanoparticles 402. Thus, as the ink 1000 is delivered to the powder bed 106 on a layer-by-layer basis according to the exemplary method 300, the first nanoparticles 1002 in the three-dimensional object 102 may undergo modification to combine with the particles 406 of the powder 104 in the powder bed 106 to form the three-dimensional object 102.

The three-dimensional object 102 formed using the ink 1000 according to the exemplary method 300 may include the plurality of layers 101 of the powder 104, with the first nanoparticles 1002 and the second nanoparticles 1004 distributed along each layer of the plurality of layers 101 of the powder 104 and defining the three-dimensional object 102. The particles 406 of the powder 104 forming the three-dimensional object 102 in such implementations may be inorganic particles (e.g. a metal or a ceramic). Continuing with this example, these inorganic particles may have a sinter temperature greater than a sinter temperature of the reduced form of the first nanoparticles 1002 following a reduction reaction of the metal oxide of the first nanoparticles 1002 and the reducing agent of the second nanoparticles 1004.

In certain implementations, modifying the first nanoparticles 1002 in the three-dimensional object 102 may include reducing the metal oxide of the first nanoparticles 1002 with the reducing agent of the second nanoparticles 1004. For example, reducing the metal oxide of the first nanoparticles 1002 with the reducing agent of the second nanoparticles 1004 may include increasing a reduction reaction, such as through the addition of heat or another form of energy, as compared to the rate of the reaction under the conditions in which the ink 1000 is delivered to the layers 101 during fabrication of the three-dimensional object 102. That is, the reduction reaction between the metal oxide of the first nanoparticles 1002 and the reducing agent of the second nanoparticles 1004 may occur at a relatively slow rate under the conditions in which the ink 1000 is delivered to the layers 101. Once the three-dimensional object 102 is formed, it may be desirable to increase the rate of the reduction reaction through the addition of heat to form the metal oxide into a metal that may be further processed. For example, through the introduction of additional heat into the three-dimensional object 102, the metal formed from reducing the metal oxide the first nanoparticles 1002 in the three-dimensional object 102 sinter to form necks 404 between the particles 406 to impart improved green strength to the three-dimensional object 102. In general, heat may be directed into the three-dimensional object 102 according to any one or more of the techniques described herein and, thus, may include heating the three-dimensional object 102 in the powder bed 106.

In certain implementations, the inorganic material of the particles 406 of the powder 104 may be a first metal and reducing the metal oxide of the first nanoparticles 1002 may form a second metal. Unless a contrary intent is indicated or made clear from the context, the first metal and the second metal may be any one or more of the combinations of metals described herein. Thus, for example, the first metal and the second metal may be the same metal. Further, or instead, the first metal and the second metal may be alloyable with one another, such as may be useful for the formation of stainless steels or other alloys.

In certain implementations, the reduction of the metal oxide via the reducing agent in the three-dimensional object may occur without the introduction of a separate reactant. Thus, for example, this reduction reaction may take place with the three-dimensional object in a vacuum environment, with the vacuum environment being useful for extracting byproduct of the reduction reaction. As compared to the use of a two-way flow to introduce a reducing agent and remove byproduct, it should be appreciated that the use of a vacuum environment may facilitate controlling the process of fabricating the three-dimensional object 102, which, in turn, may have benefits related to improved dimensional control and reduced fabrication costs (e.g., by requiring less energy).

While reducing the metal oxide via the reducing agent without the introduction of a separate reactant may have certain benefits, a reducing gas may be moved through the three-dimensional object in certain implementations. While penetration of the reducing gas through the nanoporous structure of the three-dimensional object 102 may be generally slow, the combination of the reducing gas and the reducing agent in the three-dimensional object 102 may have benefits with respect to the speed and completeness of the reduction of the metal oxide of the first nanoparticles 1002.

Multi-Phase Sintering

In general, any one or more of the three-dimensional objects described herein may be sintered according to any one or more of various different techniques compatible with, among other things, the materials forming the three-dimensional object, dimensional tolerances of the three-dimensional object, energy requirements, and throughput requirements. In certain implementations, the three-dimensional object may be heated to high temperatures just below the melting temperature of the nanoparticles forming the three-dimensional object, and the material forming the three-dimensional object may densify through solid state diffusion between the nanoparticles and the particles forming the three-dimensional object. Through such solid-state diffusion, the nanoparticles may diffuse along a length-scale on the order of tens of microns, which may be useful for shape retention and may facilitate formation of a homogeneous structure. While solid-state diffusion may be effective for forming the three-dimensional object into a final part, the heat required for this type of sintering may be time and energy consuming, and the limited diffusion of the nanoparticles may present constraints with respect to densification and homogeneity of the three-dimensional part.

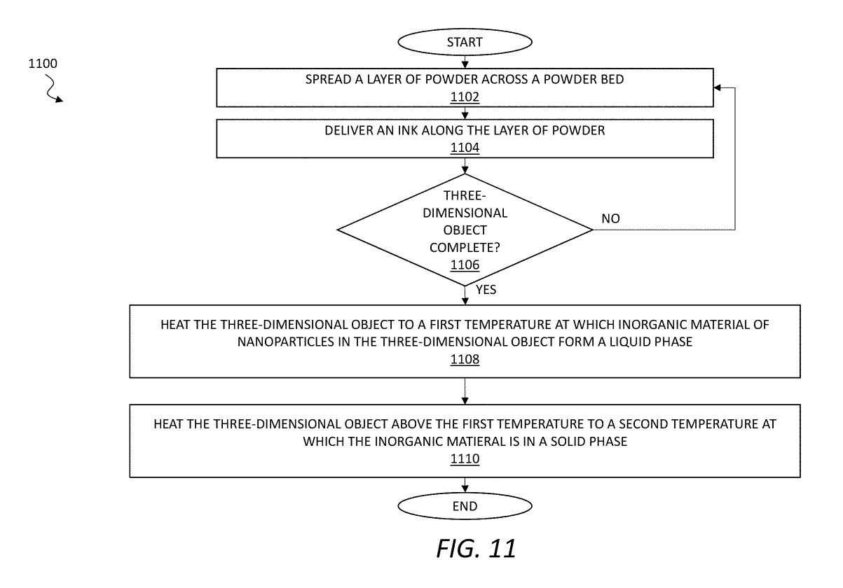

FIG. 11 is a flowchart of an exemplary method 1100 of additive manufacturing method including multi-phase sintering. In general, unless otherwise specified or made clear from the context, the exemplary method 1100 should be understood to be carried out using the additive manufacturing plant 200 (FIG. 2) including the additive manufacturing system 100 (FIG. 1) to form any one or more of the three-dimensional objects according to any one or more of the methods described herein. Because at least a portion of the material of the three-dimensional object being formed is in a liquid phase during at least a portion of the sintering process, multi-phase sintering according to the exemplary method 100 may result in the sintered material flowing over longer distances, as compared to solid-state diffusion. This improved flow of the sintered material may, for example, improve homogeneity of the three-dimensional object. Further, or instead, as compared to solid-state diffusion, multi-phase sintering according to the exemplary method 1100 may require lower temperatures to achieve densification. As used herein, multi-phase sintering should be understood to include sintering process in which at least a portion of solid material forming a three-dimensional object transforms to a liquid phase over at least a portion of a temperature range associated with the sintering process. Thus, for example, multi-phase sintering shall be generally understood to include liquid phase sintering or transient-phase liquid sintering. Aspects of the exemplary method 1100 described below should be generally understood to be applicable to liquid phase sintering and transient-liquid phase sintering, unless otherwise specified or made clear from the context.

As shown in step 1102, the exemplary method 1100 may include spreading a layer of a powder across a powder bed. In general, spreading the layer of the powder across the powder bed may be analogous to step 302 (FIG. 3) described above. The powder may include particles of a first metal, which may be an elemental metal, a metal alloy, or a metal matric composite. For example, the first metal may be any one or more of the various different metals described herein with respect to particles spread along a powder bed.

As shown in step 1104, the exemplary method 1100 may include delivering an ink to the layer of the powder in a controlled two-dimensional pattern associated with the layer. In general, delivering the ink according to step 1104 may be analogous to step 304 (FIG. 3) described above. Thus, for example, the ink may be jetted onto the layer from a printhead moving over the layer of the powder on top of the powder bed. The ink may include nanoparticles of an inorganic material such that delivery of the ink along the controlled two-dimensional pattern on the layer introduces the nanoparticles of the inorganic material into the layer. For example, the ink may include a carrier in which the nanoparticles are suspended (e.g., as a colloid) and, as the ink is delivered onto the layer, the nanoparticles may penetrate the layer through movement of the carrier into the layer.

As shown in step 1106, the exemplary method 1100 may include repeating one or more of the steps of spreading a layer of the powder across the powder bed (step 1102), delivering the ink along a given layer of powder (1104) to form a three-dimensional object. In general, the three-dimensional object formed according to the exemplary method 1100 may include a distribution of the nanoparticles of inorganic material throughout particles of the first metal, with the nanoparticles filling a substantial portion of void space of the particles of the first metal.

As shown in step 1108, the exemplary method 1100 may include heating the three-dimensional object to a first temperature at which at least a portion of the inorganic material is in a liquid phase and the particles of the first metal are in a solid phase. In certain implementations, the first temperature may be above—in some cases, substantially above—a melting temperature of the nanoparticles of the inorganic material. This may be useful, for example, for reducing the likelihood of unintended solidification of the inorganic material in response to normal variations in temperature of the three-dimensional object as the three-dimensional object undergoes multi-phase sintering. Such variations in temperature may be attributable to changing conditions surrounding and within the three-dimensional object and, further or instead, may be attributable to delays associated with temperature control equipment.

The liquid phase of the inorganic material may be disposed, for example, along points of contact of the particles of the first metal. The liquid phase of the inorganic material may flow along these regions through, for example, wicking forces on the liquid phase of the inorganic material in these regions. Heating the three-dimensional object to the first temperature may include maintaining the three-dimensional object at or above a minimum temperature for a period of time (e.g., a predetermined period of time), which may be useful for allowing physical processes such as flow of the liquid phase to proceed, such as to an equilibrium condition.

In some implementations, the liquid phase of the inorganic material may correspond to a portion of the inorganic material, with the remainder of the inorganic material remaining in a solid phase. In such implementations, the liquid phase of the inorganic material may interact with the first metal through any of various different physical processes (e.g., to form necks) while the remainder of the inorganic material in the solid phase provides support for the shape of the three-dimensional object. As an example, greater than about 0.5 percent by volume and less than about 30 percent by volume of the total volume of the inorganic material in the three-dimensional object may be in the liquid phase at the first temperature.

The inorganic material may include, for example, a second metal different from the first metal. The second metal may be any one or more of the metals described herein with respect to the nanoparticles and compatible with the first metal in a multi-phase sintering process. As an example, the first metal of the particles of the powder may be aluminum, and the second metal of the nanoparticles may be one or more of tin or magnesium. Additionally, or alternatively, at points of contact between the nanoparticles of the inorganic material and the first metal, the first metal and the second metal may form an alloy having a melting temperature less than the first temperature. Still further or instead, at or about the first temperature (e.g., within ±10 degrees Celsius) the liquid phase of the inorganic material may be consumed by dissolution of the particles of the first metal into the liquid phase of the inorganic material such that the first metal and the second metal form an alloy having a melting temperature greater than the first temperature.

In certain implementations, the inorganic material may be a eutectic composition, and the first temperature may be at or above the eutectic temperature of the eutectic composition. Because the eutectic composition has a single melting point (the eutectic temperature), in such implementations, the inorganic material in the three-dimensional object may melt at substantially the same time. Such a melting profile may be useful for achieving substantially homogeneous distribution of the inorganic material throughout the three-dimensional object. An aluminum-tin eutectic is an example of a eutectic composition that may be useful as the inorganic material. The inorganic material may also or instead include an off-eutectic near the eutectic composition such that a small solid portion remains after the eutectic composition melts at the eutectic temperature, or some other high-melting point component that remains in solid form at the eutectic temperature.

In some implementations, the inorganic material may include a plurality of components, with the plurality of components (e.g., an alloy of a plurality of metals) having a range of melting temperatures. The range of melting temperature may be useful, for example, for providing support to the shape of the three-dimensional object as individual components of the inorganic material melt over a temperature range. That is, as a low melting point component melts, higher melting point components may remain in a solid phase supporting the shape of the three-dimensional object. As the temperature of the three-dimensional object continues to increase and the three-dimensional object continues to densify (requiring less support), one or more of the higher melting point components may melt. Thus, the melting temperature range of the plurality of components may correspond to a temperature range over which the three-dimensional object requires support. In certain instances, the range of melting temperatures of the plurality of components may be below an initial melting temperature of the first metal such that the first metal remains in a solid phase as the plurality of components of the inorganic material melt over a temperature range. As a specific example, the plurality of components of the inorganic material having a useful range of melting temperatures may include tin, aluminum, and copper.

In the selection of the inorganic material and the first metal, miscibility of the materials is a criterion that may be taken into account for the purpose of achieving desired physical processes during sintering. In certain implementations, at the first temperature, the liquid phase of the inorganic material may be consumed as the liquid phase of the inorganic material dissolves into the particles of the first metal. Thus, in such implementations, as the three-dimensional object is maintained at the first temperature, all or substantially all of the liquid phase of the inorganic material may dissolve into the particles of the first metal. In other implementations, however, the inorganic material in the liquid phase may be immiscible with the first metal in the solid phase.

While the exemplary method 1100 has been generally described in the context of liquid phase sintering, it should be appreciated that the exemplary method 1100 may further or instead be carried out to achieve transient liquid-phase sintering.

As shown in step 1110, the exemplary method 1100 may include heating the three-dimensional object from the first temperature to a second temperature greater than the first temperature. For certain types of inorganic material, the inorganic material in the liquid phase at the first temperature may return to a solid phase as the temperature of three-dimensional object is increased to the second temperature. Thus, stated differently, the first metal and the inorganic material may each be in a solid at the second temperature. Through such transient-liquid phase sintering, the inorganic material may flow at the first temperature and form necks at contact points of the particles as the inorganic material returns to the solid phase. A particular advantage of such transient-phase sintering is that these necks, which may be robust, may be formed at relatively low temperatures. In some implementations, the inorganic material may be soluble in the first metal at the second temperature. Further or instead, the inorganic material may be silicon, and the first metal may be iron.

Aggregation of Nanoparticles

While inks have been described as including nanoparticles suspended in a carrier (forming, in some instances, colloids) to facilitate substantially uniform distribution of nanoparticles along a three-dimensional object being formed, controlled aggregation of nanoparticles may be useful in some applications. For example, as described in greater detail below, nanoparticles delivered to a layer in an ink may be selectively aggregated to form an interface layer resistant to sintering. Further, or instead, as also described in greater detail below, nanoparticles deliver to a layer in an ink may be aggregated to harden the ink along the layer to facilitate spreading of a subsequent layer on top of the layer with the hardened ink and, therefore, to improve uniformity of density in the powder bed.

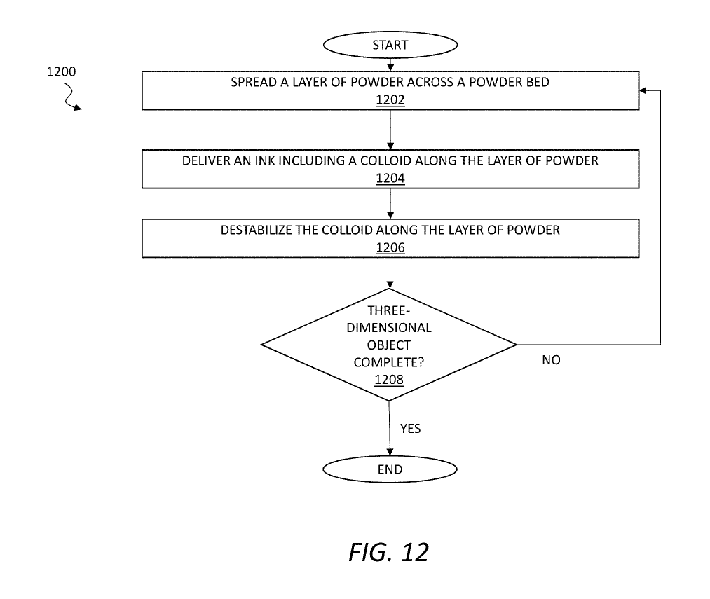

FIG. 12 is a flowchart of an exemplary method 1200 of additive manufacturing including controlled aggregation of nanoparticles. In general, unless otherwise specified or made clear from the context, the exemplary method 1200 may be carried out using the additive manufacturing plant 200 (FIG. 2) including the additive manufacturing system 100 (FIG. 1) to form any one or more of the three-dimensional objects according to any one or more of the methods described herein.

As shown in step 1202, the exemplary method 1200 may include spreading a layer of a powder across a powder bed. The layer of the powder may be spread, generally, according to any one or more of the spreading methods described herein. Thus, more specifically, the layer of the powder may be spread through the movement of a spreader, such as the spreader 116 moving from the powder supply 112 (FIG. 1) over the powder bed 106 (FIG. 1).

As shown in step 1204, the exemplary method 1200 may include delivering an ink to the layer in a controlled two-dimensional pattern associated with the layer. Delivering the ink may include, for example, jetting the ink onto the layer from one or more printheads, such as described above with respect to delivering the ink 103 (FIG. 1) from the printhead 118 (FIG. 1). The ink may include a colloid of nanoparticles suspended in a carrier. In the colloid, the nanoparticles may remain dispersed, with little or no settling over extended periods of time (e.g., weeks or months).

The nanoparticles, in certain instances, may include inorganic material that is stable in the carrier over these extended periods of time. As an example, the inorganic material may include a second metal (e.g., copper) or group of different metals, which may be alloyable with the first metal in certain applications. As an additional or alternative example, the inorganic material may include silica or titania.

The carrier may include any one or more fluids that may be delivered to the layer along a controlled pattern and, in certain instances, may be jetted onto the layer through actuation of one or more printheads. In certain implementations, the carrier may include one or more stabilizing agents useful for maintaining the ink as a colloid. Further, or instead, the carrier may include water and/or one or more polymers, as may be useful for forming a stable colloid including the nanoparticles of the inorganic material. Thus, stated differently, the composition of the carrier may be based at least in part on compatibility with the maintaining the nanoparticles of the inorganic material as a stable colloid. As described in greater detail below, the composition of the carrier may include one or more components that facilitate destabilization of the colloid in a controlled manner that may be readily achieved on a layer-by-layer basis as a three-dimensional object is fabricated.

As shown in step 1206, the exemplary method 1200 may include destabilizing the colloid along one or more sections of the two-dimensional pattern along which the ink is delivered on the layer. In general, the destabilization of the colloid may aggregate the nanoparticles along the one or more sections of the layer. As used in this context, aggregating the nanoparticles may include an irreversible process in which irregular clusters of the nanoparticles are formed.

In general, destabilizing the colloid may include changing one or more parameters of the ink. For example, destabilizing the colloid may include changing the ink from an alkaline pH (a pH greater than 7) to an acidic pH (a pH less than 7). In certain implementations, changing one or more parameters of the ink may include delivering a destabilization agent along at least a portion of the two-dimensional pattern associated with the layer. Thus, in instances in which destabilization includes changing pH of the ink, the destabilizing agent may include at least one component that is an acid such that the destabilizing agent has an overall pH of less than 7.

In certain implementations, the destabilization agent may include a liquid deliverable in a manner analogous to delivery of the ink. Thus, more specifically, the destabilization agent may be jetted onto the layer from a printhead, such as the printhead 118 (FIG. 1), moving over the powder bed. That is, the ink and the destabilization agent may be delivered to the layer in coordination with one another to produce a desired distribution of non-aggregated nanoparticles and aggregated nanoparticles. Further, or instead, the destabilization agent may include a gas in an environment above the layer, and destabilizing the colloid may include exposing all or a portion of the ink in the layer to the gas.

As shown in step 1208, exemplary method 1200 may include repeating one or more of the steps of spreading a layer of the powder across the powder bed (step 1202), delivering the ink along a given layer of powder (1204) in a respective controlled two-dimensional pattern associated with the layer and, in one or more layers, destabilizing the colloid (1206) along at least a portion of a respective two-dimensional pattern of the one or more layers. The distribution of the colloid and the aggregated nanoparticles in the layers collectively define a three-dimensional object. In general, the three-dimensional object formed according to the exemplary method 1200 may include a distribution of the nanoparticles of inorganic material throughout particles of the first metal, with the nanoparticles filling a substantial portion of void space of the particles of the first metal. Further, or instead, the three-dimensional object may include aggregated nanoparticles along one or more sections of at least one layer of the three-dimensional object.

In some instances, the one or more sections, along which the nanoparticles of the inorganic material are aggregated, may be predetermined based on design specifications associated with the three-dimensional object. For example, aggregation of the nanoparticles along the one or more sections may form an interference layer that resists bonding to adjacent regions of the three-dimensional object during sintering. Such an interference layer may be useful, for example, for forming a frangible or otherwise easily releasable separation layer between an object that is being fabricated and a support structure positioned to support one or more features of a part during printing, debinding, thermal processing, or other processing. For example, the interface layer may facilitate separating the support structure from the part without the use of specialized tools. Further or instead, the interface layer may facilitate separating the support structure from the part without damaging the part.

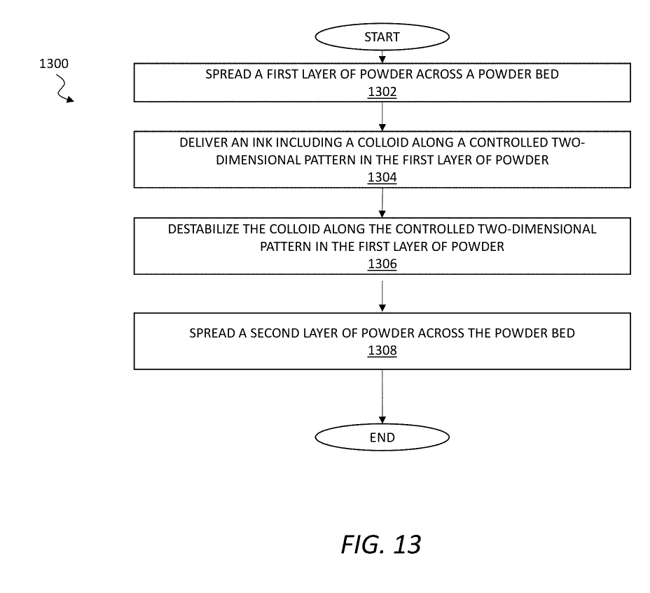

FIG. 13 is a flowchart of an exemplary method 1300 of additive manufacturing including layer-by-layer hardening of an ink forming a three-dimensional object. In general, unless otherwise specified or made clear from the context, the exemplary method 1300 may be carried out using the additive manufacturing plant 200 (FIG. 2) including the additive manufacturing system 100 (FIG. 1) to form any one or more of the three-dimensional objects according to any one or more of the methods described herein.

As shown in step 1302, the exemplary method 1300 may include spreading a first layer of a powder across a powder bed. The first layer may be spread according to any one or more of the various different techniques described herein. Further, or instead, the powder may include particles of a first metal, which may be any of various different metals described herein.

As shown in step 1304, the exemplary method 1300 may include delivering an ink to the first layer of the powder on top of the powder bed in a controlled two-dimensional pattern. The ink may include a colloid of nanoparticles of an inorganic material suspended in a carrier, and may be any one or more of the inks described above with respect to the exemplary method 1200 (FIG. 12). Thus, for example, the inorganic material may be combinable (e.g., as an alloy or a metal matrix composite) with the first metal in a finished part.

As shown in step 1306, the exemplary method 1300 may include destabilizing the colloid in the controlled two-dimensional pattern along the first layer. The destabilization of the colloid may be achieved using any one or more of the various different destabilizing agents and through any of the various different delivery methods described above with respect to the exemplary method 1200 (FIG. 12). Thus, for example, destabilizing the colloid may include changing the ink from an alkaline pH to an acidic pH. Further, or instead, destabilizing the colloid may include exposing the ink along the controlled two-dimensional pattern in the first layer to a destabilizing agent in an environment above the first layer.

Destabilizing the colloid in the controlled two-dimensional pattern may aggregate the nanoparticles along the controlled two-dimensional pattern which, in turn, may harden the portion of the first layer defined by the controlled two-dimensional pattern. As compared to conditions prior to destabilizing the colloid, the aggregation of the nanoparticles along the controlled two-dimensional pattern may improve uniformity of density along the controlled two-dimensional pattern. For example, prior to destabilizing the colloid, areas of lower density in the first layer of the powder may have more void space than areas of higher density. Continuing with this example, as the ink is delivered to the first layer along the controlled two-dimensional pattern, the ink may preferentially penetrate those areas of lower density (more void space) relative to those areas of higher density (less void space). Accordingly, because the distribution of ink may be inversely related to local density along the first layer, destabilizing the colloid along the portion of the first layer defined by the controlled two-dimensional pattern may produce a distribution of aggregated nanoparticles that reduces variations in local density along the controlled two-dimensional pattern.

As shown in step 1308, the exemplary method 1300 may include spreading a second layer of the powder across the powder bed, the second layer spread over the hardened ink in the first layer. In certain instances, the hardened ink in the first layer, along the controlled two-dimensional pattern, may resist deformation in response to forces exerted on the first layer by the spreading of the second layer. Further, or instead, the hardened ink in the first layer may provide a surface useful for achieving target parameters (e.g., thickness and/or density) associated with spreading the second layer.

Any one or more of the steps of the exemplary method 1300 may be repeated as necessary to form a three-dimensional object. Advantageously, the improvements in uniformity of density may be achieved in each layer forming the three-dimensional object and, overall, the three-dimensional object may have improved uniformity of density. Such improvement in density may, in turn, result in higher quality parts (e.g., fewer defects).

Distribution of Nanoparticles Based on Density

The density of layers used to form a three-dimensional object through binder jetting processes described herein may be controlled through one or more open-loop approaches (e.g., through controlled parameters associated with spreading powder, hardening ink along each layer, etc.). While such open-loop approaches may be readily implemented to provide a useful amount of uniformity, adjustments to open-loop parameters related to layer density may present certain challenges. That is, parameters associated with open-loop control of layer density may drift over time, resulting in a drift in shrinkage rates within and between three-dimensional objects over time. Such drifts in shrinkage rates, however, are typically observed as an increase in defects in final parts. Thus, to reduce the likelihood of producing defective final parts, closed-loop control may be used to adjust density-related parameters as the three-dimensional objects are being formed. More specifically, density-related parameters may be adjusted within a layer and/or on a layer-by-layer basis in response to feedback from one or more sensors providing a direct or indirect indication of density of each layer as the three-dimensional object is formed.

Referring again to FIG. 1, the additive manufacturing system 100 may include one or more sensors 124 positioned relative to the powder box 106 to measure one or more parameters directly or indirectly indicative of density of one layer of the plurality of layers 101 (e.g., the layer on top of the powder bed 106). The one or more sensors 124 may be in electrical communication with the controller 120 such that the controller 120 may carry out control operation (e.g., a closed-loop control operation) based at least in part on the signal or signals received by the controller 120 from the one or more sensors 124.

In certain implementations, the one or more sensors 124 may be weight sensors positioned to determine weight of the powder 104 in the powder bed 106 such that density of a given layer 101 on top of the powder bed 106 may be inferred based on an assumption regarding layer thickness, knowledge of area of the layer, and a difference in weight before and after the given layer is spread on top of the powder bed 106. Further or instead, the weight of segments of the powder bed 106 may be used in an analogous manner to determine a density associated with each respective segment of the layer. More generally, the one or more sensors may measure any property of the powder 104 in the powder bed 106 that is a function of density of the layer 101 on top of the powder bed 106. Examples of such properties include, but are not limited to, magnetic properties, electrical properties, acoustic properties, or thermal properties of the powder bed 106.

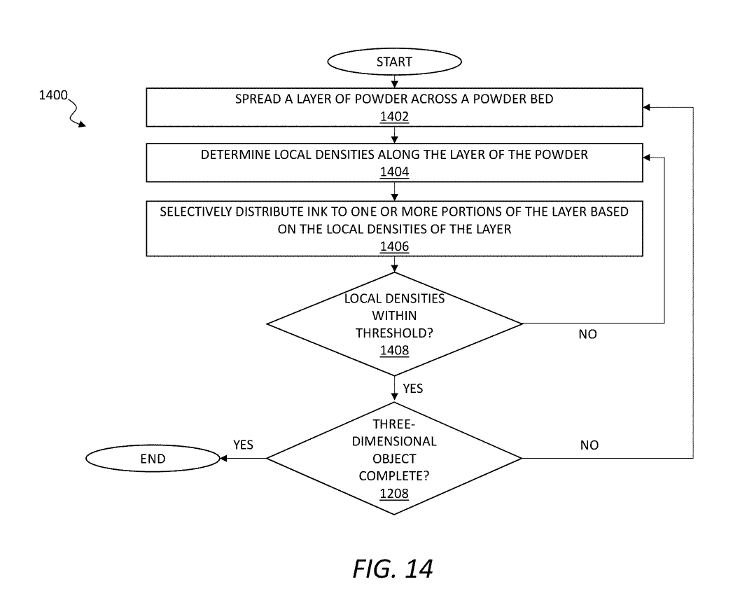

FIG. 14 is a flowchart of an exemplary method 1400 of an additive manufacturing method including distributing nanoparticles based on powder density. In general, unless otherwise specified or made clear from the context, the exemplary method 1400 may be carried out using the additive manufacturing plant 200 (FIG. 2) including the additive manufacturing system 100 (FIG. 1) to form any one or more of the three-dimensional objects according to any one or more of the methods described herein.

As shown in step 1402, the exemplary method 1400 may include spreading a layer of a powder across a powder bed. Spreading the layer of the powder across the powder bed may include, for example, moving a spreader 116 (FIG. 1) from the powder supply 112 (FIG. 1) over the powder bed 106 (FIG. 1).

As shown in step 1404, the exemplary method 1400 may include determining local densities along the layer of the powder. As used in this context, a local density may include a density of a portion (e.g., less than the entirety) of the layer. For example, the local densities may correspond to discrete portions of the layer, such as quadrants or another fraction of the layer. In certain implementations, the layer may be divided into small discrete portions such that the local densities collectively provide a substantially continuous map of density variation along the layer. In general, the local density may be determined according to any one or more of the various different methods of determining density described herein. For example, determining the local densities along the layer of the powder may include receiving a signal indicative of the weight of one or more portions of the layer of the powder in the powder bed. Further, or instead, determining the local densities along the layer of the powder bed may include receiving a signal indicative of one or more of magnetic, electrical, acoustic, or thermal properties of the powder bed.

The powder may be any one or more of the powders described herein and, therefore, may include inorganic particles, such as particles of a first metal. The inorganic particles may have a size distribution suitable for spreading and useful in combination with nanoparticles as part of any one or more of the fabrication processes described herein. Thus, as an example, the inorganic particles may have an average particle size of greater than about 0.1 microns and less than about 100 microns and a size distribution cut off at about 5 microns or greater. More generally, the inorganic particles may have a predetermined size distribution useful for controlling density of layers of the powder. That is, the inorganic particles may have a predetermined size distribution with variations that significantly reducible through the delivery of an ink containing nanoparticles, as described in greater detail below.

As shown in step 1406, the exemplary method 1400 may include selectively distributing an ink to one or more portions of the layer based on the local densities along the layer. The ink may include nanoparticles and, unless otherwise indicated or made clear from the context, may include features of any one or more of the nanoparticle-based inks described herein. As an example, the nanoparticles may be formed of the same material as the inorganic particles. Further, or instead, the nanoparticles may include a second metal and, in instances in which the inorganic particles of the powder are a first metal, may be alloyable with the first metal. The nanoparticles may have an average particle size greater than about 5 nanometers and less than about 100 nanometers. Further or instead, the ink may include a carrier such as an aqueous medium and/or a polymer. For example, the ink may include a colloid of the nanoparticles in the ink.

The selective distribution of the ink to the one or more portions of the layer may increase density of each of the one or more portions of the layer as the ink transports the nanoparticles into the layer along the one or more portions of the layer. Thus, it should be appreciated that selectively controlling distribution of the ink may be useful for improving uniformity of a given layer. That is, more ink may be distributed to a portion of the layer having a relatively low density while less ink or no ink may be distributed to a portion of the layer having a relatively higher density. Continuing with this example, the overall result of such a selective distribution of the ink is an overall increase in the average density of the layer, but a decrease in variation of density within a given layer. Such a decrease in variation in a given layer may be useful for reducing, for example, variations in shrinkage rates along the layer as a three-dimensional part, formed from the layer, is formed into a final part.

In certain implementations, selectively distributing the ink along the one or more portions of the layer may include delivering the ink in a controlled two-dimensional pattern along the layer. The controlled two-dimensional pattern may correspond to a cross-section of the three-dimensional object being formed, as described above. In certain implementations, at least one of the local densities may be associated with coordinates of the controlled two-dimensional pattern along the layer. That is, the improvement in uniformity of density achieved through the selective distribution of the ink may occur along a portion of the layer corresponding to a cross-section of the three-dimensional object being formed. Extending this example to multiple layers, it should be appreciated that the selective distribution of the ink may improve the uniformity of density along the entire three-dimensional object.

In certain instances, selectively distributing the ink along the one or more portions of the layer may include varying a volume of ink per unit area of the layer according to the respective local density associated with each of the one or more portions of the layer. Thus, for example, a larger volume of ink per unit area may be distributed along relatively low-density portions of the layer while a smaller volume of ink per unit area may be distributed along relatively high-density portions of the layer. Continuing with this example, for a given volumetric concentration of nanoparticles in the ink, such a variation in volume of the ink distributes more nanoparticles to the relatively low-density portions of the layer and fewer nanoparticles to the relatively high-density portions of the layer. In turn, this difference in distribution of the nanoparticles along the layer may be useful for reducing variation in local density between the one or more portions of the layer.

As shown in step 1408, the exemplary method 1400 may include repeating the steps of measuring local densities along the layer (step 1404) and selectively distributing the ink along the one or more portions of the layer (step 1406) based on a comparison of the local densities to at least one threshold parameter. For example, the threshold parameter may correspond to a variation in the local densities such that the ink may be selectively distributed along the one or more portions until a target variation in local densities is achieved. Additionally, or alternatively, the threshold parameter may correspond to a maximum allowable local density such that the ink may be selectively distributed along the one or more portions until at one or more of the local densities is at or above the maximum allowable local density.

As shown in step 1410, the exemplary method 1400 may include, for each of a plurality of layers, repeating the steps of spreading the respective layer (step 1402), measuring local densities along the respective layer (1404), and selectively distributing the ink along the one or more portions of the respective layer (step 1406) to form a three-dimensional object. In certain implementations, the inorganic particles may have a sinter temperature greater than a sinter temperature of the nanoparticles and, as described above, the nanoparticles may be sintered in the three-dimensional object to provide green strength to the three-dimensional object.

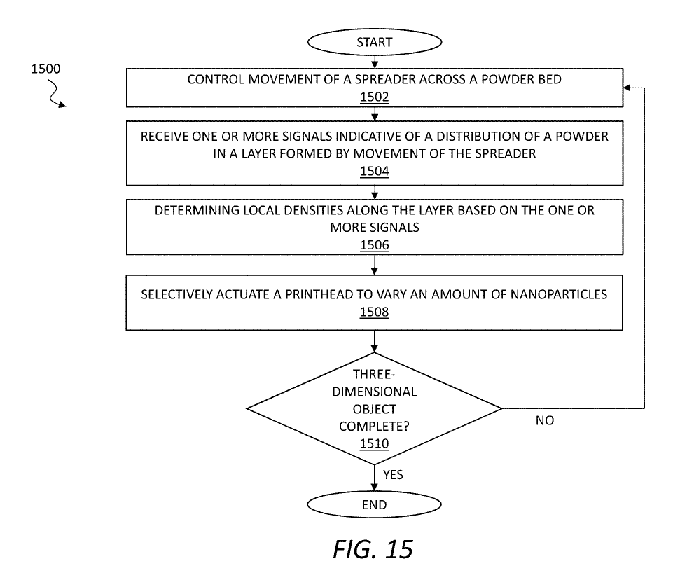

FIG. 15 is a flowchart of an exemplary method 1500 of controlling an additive manufacturing system to distribute nanoparticles based on powder density. In general, unless otherwise specified or made clear from the context, the exemplary method 1500 may be carried out using the additive manufacturing plant 200 (FIG. 2) including the additive manufacturing system 100 (FIG. 1) to form any one or more of the three-dimensional objects according to any one or more of the methods described herein. More specifically, unless a contrary intention is indicated, the storage medium 122 (FIG. 1) may have stored thereon instructions for causing the one or more processors 121 (FIG. 1) to perform the steps of the exemplary method 1500.

As shown in step 1502, the exemplary method 1500 may include controlling movement of a spreader across a powder bed. Such control of the spreader may include, for example, rate of movement and/or timing of movement according to any one or more of various different aspects associated with properly spreading a layer of any one or more of the powders described herein. In certain implementations, the movement of the spreader may be paused while the density of the layer is adjusted according to any one or more of the techniques described herein.

As shown in step 1504, the exemplary method 1500 may include receiving one or more signals indicative of a distribution of a powder in a layer formed through movement of the spreader across the powder bed. The one or more signals may correspond to measurements made by any one or more of the various different types of sensors described above. Thus, as one example, the one or more signals may correspond to weight of segments of the powder bed.

As shown in step 1506, the exemplary method 1500 may include determining local densities along the layer based on the one or more signals indicative of the distribution of the powder in the layer. Therefore, returning to the example in which the one or more signals correspond to weight of the segments of the powder, determining local densities along the layer may include determining the density based on the weight, a measured or assumed height of the layer, and knowledge of the X-Y area of the powder bed. While determining local density may include arriving at an absolute value of density (e.g., in units of kg/m³), additional or alternative forms of determining local density are possible. For example, determining local density may include arriving at a dimensionless parameter (e.g., a ratio) providing a relative indication of density based on a reference measurement (such as one or more previous measurements of density and/or a calibration measurement).

As shown in step 1508, the exemplary method 1500 may include selectively actuating a printhead to vary an amount of nanoparticles delivered from the printhead to one or more portions of the layer according to the respective local density associated with the one or more portions of the layer. Unless otherwise indicated or made clear from the context, the printhead may have any one or more of the features of the printhead 118 (FIG. 1). Additionally, or alternatively, the printhead may deliver (e.g., jet) any one or more of the nanoparticle-based inks described herein. Thus, as a specific example, the printhead may be moveable over the powder bed to deliver a nanoparticle-based ink in a controlled two-dimensional pattern along the layer. The controlled two-dimensional pattern may, for example, correspond to a cross-section of a three-dimensional object being formed. Further, or instead, at least one of the local densities may be associated with coordinates of the controlled two-dimensional pattern along the layer.

In certain implementations, selectively actuating the printhead to vary the amount of the nanoparticles delivered from the printhead to the one or more portions of the layer may include varying a volume of ink delivered from the printhead per unit area of the layer based on a predetermined volumetric concentration of nanoparticles in the ink. As described above, for a given volumetric concentration of the nanoparticles in the ink, varying the volume of the ink delivered from the printhead to the one or more portions of the layer may produce an associated variation in the amount of nanoparticles along the one or more portions of the layer.

As shown in 1510, the exemplary method 1500 may include, for each layer of a plurality of layers, repeating the steps of controlling movement of the spreader across the powder bed (1502), receiving one or more signals indicative of a distribution of the powder in the respective layer (1504), determining local densities along the respective layer based on the one or more signals (1506), and selectively actuating the printhead to vary an amount of nanoparticles delivered from the printhead to one or more portions of the layer according to the respective local density associated with each of the one or more portions of the layer to form a three-dimensional object.

Nanoparticle-Coated Powder Particles

While nanoparticles have been described as being introduced into a layer of powder via an ink delivered onto the layer of the powder, other techniques for distribution of nanoparticles in a layer of power are additionally or alternatively possible. For example, the nanoparticles may form a component of the powder such that the nanoparticles are present in the layer prior to delivery of the ink used to bind the powder along a controlled two-dimensional pattern. An example of nanoparticles forming a component of the powder is found, for example, in U.S. patent application Ser. No. 15/692,819, the entire content of which is incorporated herein by reference in its entirety.

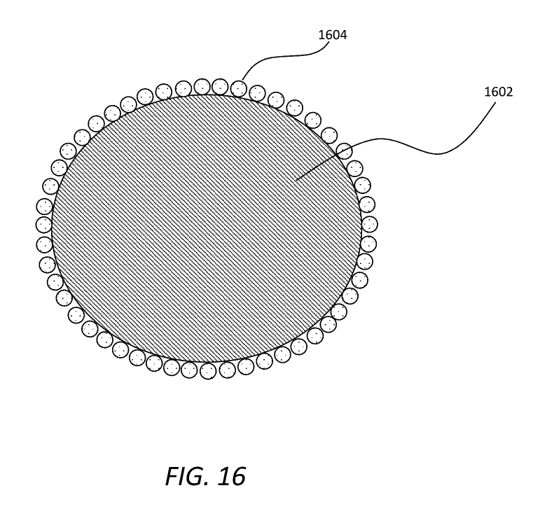

Referring now to FIG. 16, a particle 1602 may be coated with nanoparticles 1604. For the sake of clarity, FIG. 16 depicts a single coated particle. It should be readily understood that a plurality of instances of the particle 1602 coated with the nanoparticles 1604 may collectively form a powder that may be spread according to layer-by-layer fabrication techniques executable using the additive manufacturing plant 200 (FIG. 2) including the additive manufacturing system 100 (FIG. 1), as described above. Thus, for example, unless otherwise specified or made clear from the context, a powder including a plurality of instances of the particle 1602 coated with nanoparticles 1604 may be used interchangeably with the powder 104 (FIG. 1). For the sake of clarity of explanation, the particle 602 depicted in FIG. 16 may be referred to in the plural to refer to a plurality of instances of the particle 602, such as in the form of a powder.

The coating of the may be applied by wet milling of a suspension containing the nanoparticle 1604 with the particles 1602, spin coating of a solution of the nanoparticles 1604 onto a layer of powder of the particles 1602, infiltration of a suspension laden with the nanoparticles 1604 into a powdered compact and subsequent drying of the suspending medium, and drying of a stirred suspension/slurry containing both the powder of the particles 1602 and the nanoparticles 1604, along with any other methods common in the art for coating a powder with a smaller powder. Any of these coating methods may be performed with or without a small amount of polymeric binder to enhance adhesion of the nanoparticles 1604 to the particles 1602. In some instances, attractive forces inherent to the interactions between the particles 1602 and nanoparticles 1604 (such as Van der Waals forces) may be sufficiently strong that there is no need to provide a binder during these coating process. The particle 1602 may include, for example, a first metal, such as any one or more of the metals described herein. Further, or instead, the nanoparticles 1604 may be an inorganic material (e.g., a metal and/or a ceramic), such as any one or more of the inorganic materials described herein. In certain implementations, the first metal associated with particle 1602 and the inorganic material associated with the nanoparticles 1604 are compatible with one another such that the nanoparticles 1604 may be directly coated onto the particle 1602 without the use of additional material.

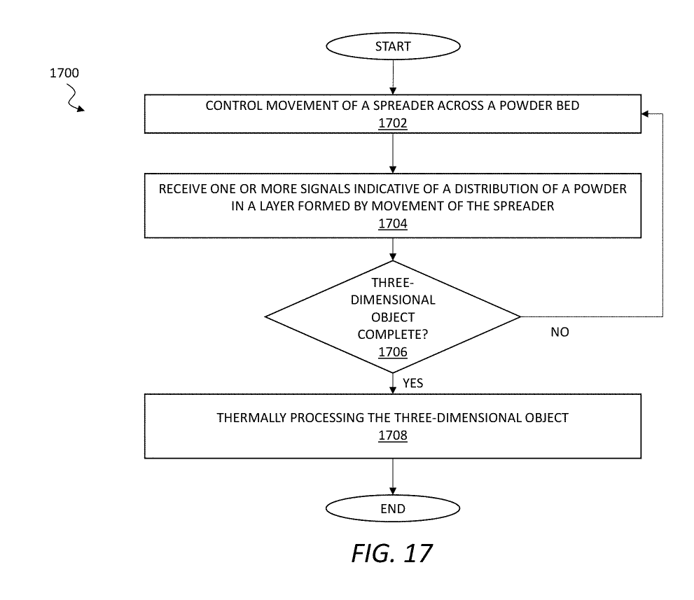

FIG. 17 is a flowchart of an exemplary method 1700 of additive manufacturing a three-dimensional object from a powder including particles coated with nanoparticles. In general, unless otherwise specified or made clear from the context, the exemplary method 1700 may be carried out using the additive manufacturing plant 200 (FIG. 2) including the additive manufacturing system 100 (FIG. 1) to form any one or more of the three-dimensional objects according to any one or more of the methods described herein.

As shown in step 1702, the exemplary method 1700 may include spreading a layer of a powder across a powder bed. The powder may include particles of a first metal and nanoparticles of an inorganic material. The inorganic material may be a second metal, which may be the same as the first metal, may be alloyable with the first metal, or may be otherwise combinable with the first metal in a final part. More specifically, the nanoparticles of the inorganic material may be coated on the particles of the first metal, such as described above with respect to FIG. 16. Spreading the powder including such coated particles may generally include moving the spreader 116 (FIG. 1) to move the powder from a powder supply across a powder bed. Because the particles of the powder are coated with nanoparticles, the nanoparticles be understood to be distributed throughout the layer.

The particles of the powder may have any of various different size distributions and, more specifically, may have any one or more of the various different size distributions described herein. Thus, for example, the particles in an uncoated state may have an average size distribution of greater than about 0.1 microns and less than about 100 microns. Further, or instead, a size distribution of the particles in the uncoated state may be cut off at a predetermined value (such as about 5 microns or higher). Similarly, the nanoparticles may have any one or more of various different size distributions compatible with a given distribution of the particles. For example, prior to coating, the nanoparticles may have an average particle size of greater than about 1 nanometer and less than about 100 nanometers (e.g., greater than about 5 nanometers and less than about 50 nanometers).

As shown in step 1704, the exemplary method 1700 may include delivering an ink to the layer of the powder in a controlled two-dimensional pattern on the layer on top of the powder bed. Delivering the ink may include jetting the ink from a printhead moving over the layer on top of the powder bed, according to any one or more of the techniques described herein. Further, because the particles of the powder in the layer are coated with nanoparticles, the ink may be free or substantially free of nanoparticles in certain implementations. Further, or instead, the ink may include a polymer or another material that may bind the particles of the powder to one another along the controlled two-dimensional pattern. In certain implementations, the ink may include nanoparticles that may interact with the nanoparticles coated on the particles in the layer. That is, for example, the ink may include nanoparticles having the same composition as the nanoparticles coated on the particles in the layer. Additionally, or alternatively, the ink may include nanoparticles different from the nanoparticles coated on the particles in the layer and yet compatible with the nanoparticles coated on the particles in the layer in the fabrication of a three-dimensional object. In certain implementations, the inorganic material of the nanoparticles may include an oxide of the second metal, and the ink may include a reducing agent of the oxide of the second metal such that delivering ink to the layer in the controlled two-dimensional pattern may reduce at least a portion of the metal oxide to the second metal in the layer.

As shown in step 1706, for each layer of a plurality of layers, the steps of spreading a respective layer of the powder across the powder bed (step 1702) and delivering the ink to the respective layer of the powder in a respective controlled two-dimensional pattern on the layer on top of the powder bed (step 1704) may be repeated to form a three-dimensional object. The resulting three-dimensional object may include, for example, a plurality of layers of the powder formed of the particles of the first metal coated with nanoparticles of the inorganic material. Continuing with this example, the ink may be distributed along respective two-dimensional patterns in each layer of the plurality of layers of the powder, with the two-dimensional patterns of the ink along the plurality of layers of the powder collectively defining a perimeter of the three-dimensional object. In general, the nanoparticles of the inorganic material may be thermally processable into necks between the particles on which the nanoparticles are coated.

As shown in step 1708, the exemplary method 1700 may include thermally processing the three-dimensional object. For example, thermally processing the three-dimensional object may include heating the three-dimensional object according to any one or more of the techniques described herein. Further, or instead, the particles of the first metal may have a sinter temperature greater than a sinter temperature of the nanoparticles such that the nanoparticles may be sintered in the three-dimensional object. Further, or instead, the ink may include at least one polymer having a decomposition temperature less than the sinter temperature associated with the nanoparticles such that the at least one polymer may at least begin to decompose prior to sintering the nanoparticles as the three-dimensional object is heated. Such decomposition of the polymer relative to sintering of the nanoparticles may, for example, facilitate effective removal of the polymer. In certain implementations, thermally processing the three-dimensional object may include reacting the ink with at least some of the inorganic material in the three-dimensional object (e.g., via a reduction reaction) to form a second metal.

Supramolecular Assemblies for Segregating Nanoparticles in Inks

While stability of nanoparticles in inks has been described as being achievable through a variety of chemical techniques, other approaches to achieving stability of nanoparticles in inks are additionally or alternatively possible. For example, as described in greater detail below, inks may include supramolecular assemblies segregating nanoparticles from one or more components of the ink that may act to degrade the nanoparticles. In use, the supramolecular assemblies may be disrupted just before the ink is delivered onto a layer of powder or as the ink is being delivered onto the layer of powder such that the components of the ink may mix, and the ink may be useable to form a three-dimensional object according to any one or more of the layer-by-layer fabrication techniques described herein.

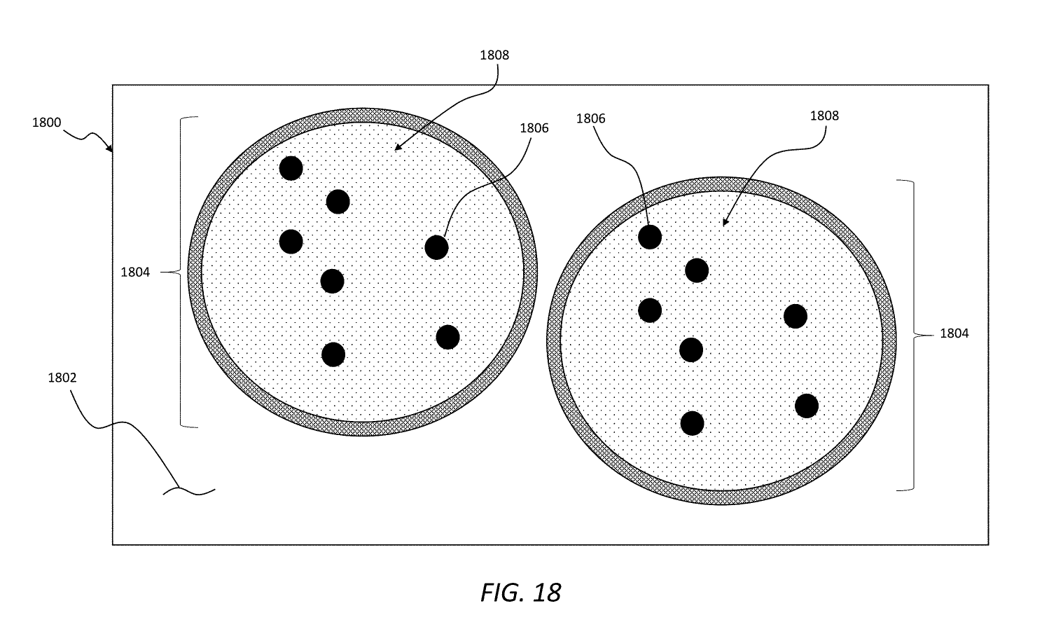

Referring now to FIG. 18, an ink 1800 may include a first carrier 1802, supramolecular assemblies 1804, and nanoparticles 1806 of an inorganic material (e.g., at least one metal, such as one or more of silver, gold, nickel, cobalt, molybdenum, vanadium, or chromium, and, in some instances, a plurality of metals alloyable with one another). In the context of the ink 1800, the supramolecular assemblies 1804 may include micelles. As described in greater detail below, however, other types of supramolecular assemblies 1804 are additionally, or alternatively, possible.

The supramolecular assemblies 1804 of molecules may be suspended in the first carrier 1802. In certain implementations, the supramolecular assemblies 1804 in the first carrier 1802 may be a colloid. Further, or instead, the supramolecular assemblies 1804 may provide a useful limit to aggregation of the nanoparticles 1806 in the ink 1800 as the supramolecular assemblies 1804 may provide a physical barrier to aggregation between nanoparticles 1806 in different supramolecular assemblies 1804.

In general, the supramolecular assemblies 1804 are stable in the first carrier 1802, which may be an oxidizing solution such as an aqueous solution. As described in greater detail below, the supramolecular assemblies 1804 may define volumes 1808. The nanoparticles 1806 may be disposed in the volumes 1808 such that the nanoparticles 1806 are sequestered from the first carrier 1802. As used in this context, the sequestration shall be understood to include substantial physical separation such that little or no interaction occurs between the nanoparticles 1806 inside of the volumes 1808 and first carrier 1802 outside of the volumes 1808. Thus, for example, the supramolecular assemblies 1804 may facilitate maintaining stability of the nanoparticles 1806 in instances in which the nanoparticles 1806 are degradable (e.g., through oxidation) in the first carrier 1802. That is, the supramolecular assemblies 1804 may provide physical separation between components of the ink 1800 to facilitate the use of combinations of carriers and nanoparticles that would otherwise be unstable and, thus, unsuitable for commercial fabrication processes.

In certain implementations, the nanoparticles 1806 of the inorganic material may be less chemically reactive in the volumes 1808 defined by the supramolecular assemblies 1804 than in the first carrier 1802. As an example, the nanoparticles 1806 of the inorganic material may be less oxidizable in the volumes 1808 defined by the supramolecular assemblies 1804 than in the first carrier 1802. Additionally, or alternatively, the volumes 1808 may be substantially free of the first carrier 1802. As an example, a concentration of the first carrier 1802 inside of the volumes 1808 may be substantially less (e.g., by a factor of 10 or, in some instances, by a factor of 100—such as may be dictated by the mechanism of formation of certain types of supramolecular assemblies 1804, such as micelles, which is described in greater detail below) than a concentration of the first carrier 1802 outside of the volumes 1808. Further, or instead, the nanoparticles 1806 be may substantially inert with respect to the supramolecular assemblies 1804.

In some implementations, the nanoparticles 1806 of the inorganic material may be coated with one or more materials useful for resisting one or more modes of degradation of the nanoparticles 1806 of the inorganic material. For example, the nanoparticles 1806 may be coated with a passivating material, such as a polymer physically adsorbed to the inorganic material or a polymer covalently grafted to the inorganic material.

In general, the supramolecular assemblies 1804 may be any one or more of various different well-defined complexes of molecules held together by noncovalent bonds. In particular, the supramolecular assemblies 1804 may be in the form of a substantially spherical shape. As an example, the molecules forming the supramolecular assemblies 1804 may include amphiphilic molecules (e.g., a triglyceride), with each amphiphilic molecule including a hydrophilic head region and a hydrophobic tail opposite the hydrophilic head region. Continuing with this example, in instances in which the first carrier 1802 is an aqueous solution, the molecules may arrange themselves in the aqueous solution such that at least some of the supramolecular assemblies 1804 are micelles. More specifically, an outer portion of each supramolecular assembly 1804 may be a non-polar portion of a micelle, and the volume 1808 of each supramolecular assembly 1804 may be a polar portion of a micelle. Given that the micelles are supramolecular assemblies that form to expel the aqueous solution, it should be understood that a relatively little amount of the aqueous solution remains in the volumes 1808 of the supramolecular assemblies 1804 formed as micelles.

In certain implementations, the molecules forming the supramolecular assemblies 1804 may include one or more block co-polymers. Examples of such block co-polymers include, but are not limited to poly(styrene-ethylene oxide) and poly(ethylene oxide-butadiene).

To facilitate maintaining the supramolecular assemblies 1804 in stable state in the ink 1800, the supramolecular assemblies 1804 may be tuned for one or more specific decomposition mechanisms. In general, through the one or more decomposition mechanisms, the supramolecular assemblies 1804 may be decomposed to allow for mixing between the contents of the supramolecular assemblies 1804 (e.g., the nanoparticles 1806) and the first carrier 1802. For example, the supramolecular assemblies 1804 may be decomposable by exposure to ultraviolet light or to another form of electromagnetic radiation such that, just prior to, during, or just after delivery of the ink 1800 to a layer, the ink 1800 may be exposed to the energy source to degrade the supramolecular assemblies 1804. Additionally, or alternatively, supramolecular assemblies 1804 may be decomposable based on a change in temperature and/or pH of the first carrier 1802. As an additional, or alternative example, the supramolecular assemblies 1804 may be separable by shear forces such as those imparted on the ink 1800 during a delivery process (e.g., a delivery process including jetting from the printhead 118 in FIG. 1).

While supramolecular assemblies in the form of micelles have been described, inks may include additional or alternative types of supramolecular assemblies.

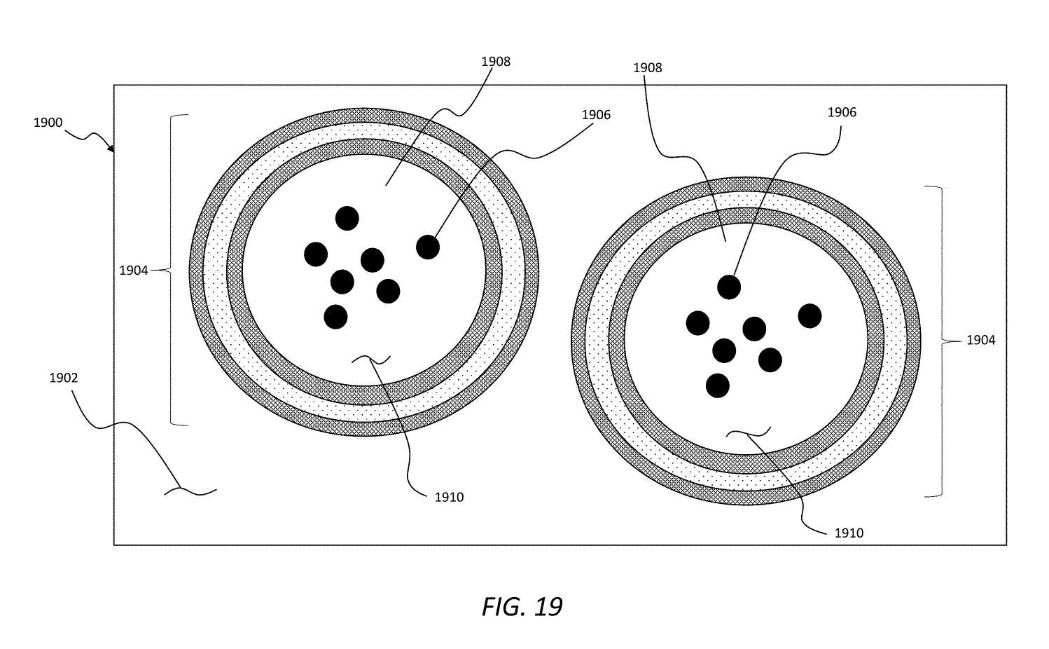

Referring now to FIG. 19, an ink 1900 may include a first carrier 1902, supramolecular assemblies 1904, and nanoparticles 1906. In general, unless otherwise specified or made clear from the context, the first carrier 1902 and the nanoparticles 1906 may be analogous to the first carrier 1802 and the nanoparticles 1806, respectively, of FIG. 18. Thus, for the sake of efficient description, these elements are not described separately with respect to FIG. 19, except to indicate any differences.

The supramolecular assemblies 1904 may be bilayers, such as liposomes and, more particularly, liposomes formed by a phospholipid. The nanoparticles 1906 may be in volumes 1908 defined by the bilayers. More specifically, the nanoparticles 1906 may be sequestered in the volumes 1908 such that the nanoparticles 1906 are separated from the first carrier 1902 and, thus, the inorganic material of the nanoparticles 1906 may remain stable.

The supramolecular assemblies 1904 may be formed of any one or more of the materials described herein as being suitable for forming supramolecular assemblies. Thus, more specifically, the supramolecular assemblies 1904 may be formed of an amphiphilic molecule and/or a di-block co-polymer. Additionally, or alternatively, the supramolecular assemblies 1904 may include a first set of block co-polymers and a second set of block co-polymers, with the second set of block co-polymers having, for example, a concentration of less than about 50 percent of the concentration of the first set of block-copolymers. In certain implementations, at least one component of the first set of block co-polymers and the second set of block co-polymers has a surface group present on an exterior of the supramolecular assemblies 1904. The at least one component may, for example, interact with material outside of the supramolecular assemblies 1904. More specifically, the at least one component may interact with a powder upon which the ink 1900 is delivered during use.

The ink 1900 may, further or instead, include a second carrier 1910, which may be disposed in the volumes 1908 defined by the bilayers 1904. In certain implementations, the second carrier 1910 may be the same as the first carrier 1902. Additionally, or alternatively, the first carrier 1902 and the second carrier 1910 may have different properties (such as different pH levels and/or one or more different constituent components). For example, the differences in properties between the first carrier 1902 and the second carrier 1910 may generally be such that the nanoparticles 1906 are less chemically reactive in the second carrier 1910 than in the first carrier 1902. While the first carrier 1902 and the second carrier 1904 may have different properties, it should be appreciated that the first carrier 1902 and the second carrier 1910 may nevertheless be similar enough to reduce the likelihood of disrupting the supramolecular assemblies 1904. In certain implementations, the second carrier 1910 may include one or more of a cyclic ketone (e.g., hexanone) or an aliphatic hydrocarbon (e.g., an alcohol).

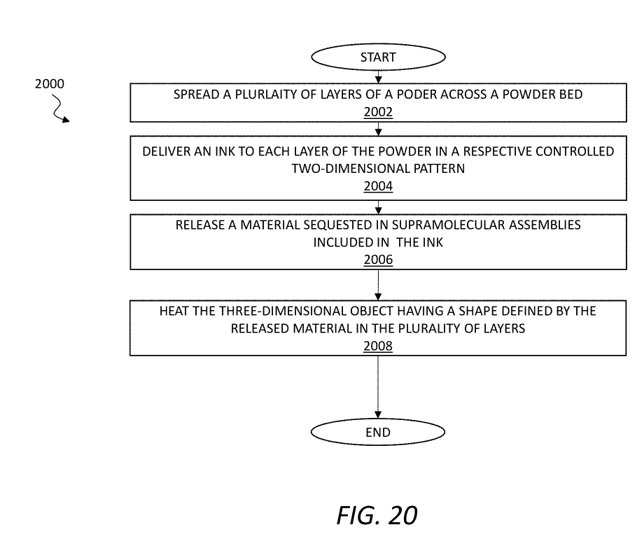

FIG. 20 is a flowchart of an exemplary method 2000 of additive manufacturing a three-dimensional object using an ink including supramolecular assemblies. In general, unless otherwise specified or made clear from the context, the exemplary method 2000 should be understood to be carried out using the additive manufacturing plant 200 (FIG. 2) including the additive manufacturing system 100 (FIG. 1) to form any one or more of the three-dimensional objects according to any one or more of the methods described herein.

As shown in step 2002, the exemplary method 2000 may include spreading a plurality of layers of a powder across a powder bed. The powder may be any one or more of the powders described herein and, similarly, spreading may be carried out on a layer-by-layer basis according to any one or more of the methods described herein.

As shown in step 2004, the exemplary method 2000 may include delivering an ink to each layer of the powder in a respective controlled two-dimensional pattern as the respective layer of the powder is on top of the powder bed. The ink may include supramolecular assemblies of molecules suspended in a first carrier (e.g., as a colloid). As specific examples, the ink may include features of any one or more of the ink 1800 (FIG. 18) or the ink 1900 (FIG. 19).

As shown in step 2006, the exemplary method 2000 may include releasing a material sequestered in the supramolecular assemblies. The released material along the plurality of layers collectively defining a shape of a three-dimensional object in the powder bed.

In general, the powder along the respective controlled two-dimensional pattern in each layer may be bindable, via one or more components of the material, to itself and to the adjacent layers to form a three-dimensional object in the powder bed. For example, the material may include nanoparticles of an inorganic material (e.g., a metal or a ceramic), such as any one or more of the inorganic materials described herein. The nanoparticles of the inorganic material may be, for example, less chemically reactive in the supramolecular assembly than in the first carrier, such that the supramolecular assembly may provide a useful barrier to degradation of the nanoparticles, as described above. Additionally, or alternatively, the nanoparticles of inorganic material may have a first sintering temperature, and particles of the powder may have a second sintering temperature less than the first sintering temperature.

In certain implementations, releasing the material carried in the supramolecular assemblies may include decomposing noncovalent bonds between molecules forming the supramolecular assemblies. For example, decomposing the noncovalent bonds between the molecules may include exposing the supramolecular assemblies to electromagnetic radiation (e.g., ultraviolet light) energy sufficient to disrupt the noncovalent bonds. Such exposure to electromagnetic radiation may include directing the electromagnetic radiation along each layer of the powder as the respective layer of the powder is on top of the powder bed. Additionally, or alternatively, decomposing the noncovalent bonds between the molecules forming the supramolecular assemblies may include shearing the supramolecular assemblies as the ink moves through a printhead as the ink is delivered to a respective layer. Further or instead, decomposing noncovalent bonds between the molecules forming the supramolecular assemblies may include changing a temperature of the supramolecular assemblies to vary a critical solution temperature of the molecules forming the respective supramolecular assemblies. Still further or instead, decomposing the noncovalent bonds between the molecules forming the supramolecular assemblies may include changing a local pH of the material sequestered in the supramolecular assemblies. For example, the material sequestered in the supramolecular assemblies may include a photobase, and changing the local pH of the material sequestered in the supramolecular assemblies may include exposing the material to a light source sufficient to activate the photobase. In an analogous manner, the material sequestered in the supramolecular assemblies may include a photoacid and changing the local PH of the material sequestered in the supramolecular assemblies may include exposing the material to a light source sufficient to activate the photoacid.

As shown in step 2008, the exemplary method 2000 may further include heating the three-dimensional object. Returning to the example in which the nanoparticles of inorganic material have a first sintering temperature less than a second sintering temperature of the particles of the powder, heating the three-dimensional object may include heating the object (e.g., in the powder bed) to a temperature between the first sintering temperature and the second sintering temperature such that the nanoparticles sinter to form necks between particles of the powder, providing green-strength to the three-dimensional object.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. An additive manufacturing method, the method comprising:
spreading a plurality of layers of a powder across a powder bed, the powder including particles of a first metal;
delivering an ink to each layer of the plurality of layers of the powder in a respective controlled two-dimensional pattern associated with each layer, the ink including ceramic nanoparticles, and the controlled two-dimensional patterns of the plurality of layers collectively defining a three-dimensional object; and
modifying the ceramic nanoparticles in the three-dimensional object, the modification of the ceramic nanoparticles combining at least one material component of the ceramic nanoparticles with the first metal in the three-dimensional object.

2. The method of claim 1, wherein the particles of the first metal have a first average particle size and the ceramic nanoparticles have a second average particle size less than the first average particle size.

3. The method of claim 1, wherein the at least one material component of the ceramic nanoparticles is an element decomposable into a second metal.

4. The method of claim 3, wherein the second metal is alloyable with the first metal.

5. The method of claim 1, wherein combining the at least one material component of the ceramic nanoparticles with the first metal includes sintering the three-dimensional object.

6. The method of claim 5, wherein sintering the three-dimensional object includes heating the three-dimensional object in the powder bed.

7. The method of claim 6, wherein the powder bed is heated to a temperature greater than a sinter temperature of the ceramic nanoparticles and less than a sinter temperature of the particles of the first metal.

8. The method of claim 1, wherein modifying the ceramic nanoparticles in the three-dimensional object includes decomposing the ceramic nanoparticles to the at least one material component.

9. The method of claim 8, wherein decomposing the ceramic nanoparticles includes exposing the three-dimensional object to a reducing environment for the ceramic nanoparticles.

10. The method of claim 1, wherein modifying the ceramic nanoparticles in the three-dimensional object includes dissolving the ceramic nanoparticles into the first metal.

11. The method of claim 1, wherein the ceramic nanoparticles include at least one metal oxide.

12. The method of claim 11, wherein the at least one metal oxide includes one or more of copper oxide, iron oxide, nickel oxide, or chromium oxide.

13. The method of claim 1, wherein the ceramic nanoparticles include at least one metal nitride.

14. The method of claim 13, wherein the at least one metal nitride includes one or more of chromium nitride or boron nitride.

15. The method of claim 1, wherein the ceramic nanoparticles include at least one metal hydride.

16. The method of claim 15, wherein the at least one metal hydride includes titanium hydride.

17. The method of claim 1, wherein the ceramic nanoparticles are formed of at least one carbide.

18. The method of claim 17, wherein the at least one carbide includes one or more of silicon carbide, vanadium carbide, tungsten carbide, or chromium carbide.

19. The method of claim 18, wherein the ink further includes a polymer in which the ceramic nanoparticles are suspended as the ink is delivered to each layer of the powder.

20. The method of claim 19, wherein the polymer has a decomposition temperature of greater than about 300° C.
